(19) United States
(12) Patent Application Publication
(10) Pub. No.: US 2022/0038929 A1
(43) Pub. Date: Feb. 3, 2022

(54) TERMINAL DEVICE, BASE STATION DEVICE, METHOD, AND INTEGRATED CIRCUIT

(71) Applicants: SHARP KABUSHIKI KAISHA, Sakai City, Osaka (JP); FG Innovation Company Limited, Tuen Mun (HK)

(72) Inventors: HIDEKAZU TSUBOI, Sakai City, Osaka (JP); TAKAKO HORI, Sakai City, Osaka (JP); SHOHEI YAMADA, Sakai City, Osaka (JP)

(21) Appl. No.: 17/429,157

(22) PCT Filed: Feb. 6, 2020
(86) PCT No.: PCT/JP2020/004487

§ 371 Date: Aug. 25, 2021

(30) Foreign Application Priority Data
Feb. 7, 2019 (JP) 2019-020708

(51) Int. Cl. H04W 24/08; H04W 24/10; H04W 76/15

(52) U.S. Cl. CPC H04W 24/08; H04W 76/15; H04W 24/10

(57) ABSTRACT

A terminal apparatus includes a receiver configured to receive a first message and a controller configured to perform a measurement based on a measurement configuration included in the first message. The measurement configuration is associated with a secondary cell group. The controller releases the measurement configuration based on a release of Multi Radio access technology (RAT)-Dual Connectivity (MR-DC).

The present invention relates to a terminal apparatus, a base station apparatus, a method, and an integrated circuit. This application is the National Stage of International Patent Application No. PCT/JP2020/004487, filed on Feb. 6, 2020, which claims priority to and benefit of Japanese Patent Application JP 2019-20708 filed in Japan on Feb. 7, 2019, the contents of which are incorporated herein by reference.

### TECHNICAL FIELD

### Background Art

A radio access method and a radio network for cellular mobile communications (which will hereinafter be referred to as “Long Term Evolution (LTE; trade name)” or “Evolved Universal Terrestrial Radio Access (E-UTRA)”) and a core network (which will be referred to as “Evolved Packet Core or EPC”) have been studied by the 3rd Generation Partnership Project (3GPP).

As a radio access method and a radio network technology for a 5th generation cellular system, technical studies and standardization of LTE-Advanced Pro which is an enhanced technology of LTE and New Radio technology (NR) which is a new radio access technology have been conducted by the 3GPP (NPL 1). 5th Generation Core Network (5GC), which is a core network for the 5th generation cellular system, has also been studied (NPL 2).

### CITATION LIST

### Non-Patent Literature

NPL 1: 3GPP RP-170855, “Work Item on New Radio (NR) Access Technology”
NPL 2: 3GPP TS 23.501, v15.3.0, “System Architecture for the 5G System; Stage 2”
NPL 3: 3GPP TS 36.300, v15.3.0, “Evolved Universal Terrestrial Radio Access (E-UTRA) and Evolved Universal Terrestrial Radio Access Network (E-UTRAN); Overall description; Stage 2”
NPL 4: 3GPP TS 36.331, v15.3.0, “Evolved Universal Terrestrial Radio Access (E-UTRA); Radio Resource Control (RRC); Protocol specifications”
NPL 5: 3GPP TS 36.323, v15.3.0, “Evolved Universal Terrestrial Radio Access (E-UTRA); Packet Data Convergence Protocol (PDCP) specification”
NPL 6: 3GPP TS 36.322, v15.3.0, “Evolved Universal Terrestrial Radio Access (E-UTRA); Radio Link Control (RLC) protocol specification”
NPL 7: 3GPP TS 36.321, v15.3.0, “Evolved Universal Terrestrial Radio Access (E-UTRA); Medium Access Control (MAC) protocol specification”
NPL 8: 3GPP TS 37.340, v15.4.0, “Evolved Universal Terrestrial Radio Access (E-UTRA) and NR; Multi-Connectivity; Stage 2”
NPL 9: 3GPP TS 38.300, v15.3.0, “NR; NR and NG-RAN Overall description; Stage 2”
NPL 10: 3GPP TS 38.331, v15.3.0, “NR; Radio Resource Control (RRC); Protocol specifications”
NPL 11: 3GPP TS 38.323, v15.3.0, “NR; Packet Data Convergence Protocol (PDCP) specification”
NPL 12: 3GPP TS 38.322, v15.3.0, “NR; Radio Link Control (RLC) protocol specification”
NPL 13: 3GPP TS 38.321, v15.3.0, “NR; Medium Access Control (MAC) protocol specification”
NPL 14: 3GPP TS 23.401 v15.0.0, “General Packet Radio Service (GPRS) enhancements for Evolved Universal Terrestrial Radio Access Network (E-UTRAN) access”
NPL 15: 3GPP TS 23.502, v15.3.0, “Procedure for 5G System; Stage 2”
NPL 16: 3GPP TS 37.324, v15.1.0, “NR; Service Data Adaptation Protocol (SDAP) Specification”
NPL 17: 3GPP RP-161266, “5G Architecture Options-Full Set”

### SUMMARY OF INVENTION

### Technical Problem

As one of the technical studies of NR and other radio access technologies (RATs), a mechanism called Multi-RAT Dual Connectivity (MR-DC) is being studied that allows cells of RATs of both E-UTRA and NR to be grouped into a cell group on a RAT basis and to be allocated to a UE, or two cell groups of NR to be allocated to a UE such that a terminal apparatus communicates with one or more base station apparatuses (NPL 8).

However, since the formats and functions of the communication protocols used in E-UTRA and NR are different, or the core network utilized is different depending on the form of the MR-DC as described in NPL 8, there is a problem in that the protocol processing is complex compared to Dual Connectivity in existing LTE using only E-UTRA as the RAT and using only EPC, which is the core network of LTE, as the core network, and thus a base station apparatus and a terminal apparatus are not able to efficiently communicate with each other.

In view of the circumstances described above, an object of one aspect of the present invention is to provide a terminal apparatus capable of efficiently communicating with a base station apparatus, a base station apparatus, a method used for the terminal apparatus, and an integrated circuit mounted in the terminal apparatus.

### Solution to Problem

In order to accomplish the object described above, a first aspect of the present invention is a terminal apparatus including: a receiver configured to receive a first message; and a controller configured to perform a measurement based on a measurement configuration included in the first message, the measurement configuration being associated with a secondary cell group, wherein the controller releases the measurement configuration based on a release of Multi Radio access technology (RAT)-Dual Connectivity (MR-DC).

A second aspect of the present invention is a base station apparatus including: a processing unit configured to notify a terminal apparatus, for which a secondary cell group of NR is configured in MR-DC, of a release of the MR-DC, wherein notification of the release of the MR-DC causes the terminal apparatus to release a measurement configuration associated with the secondary cell group.

A third aspect of the present invention is a method applied to a terminal apparatus, the method including: receiving a first message; performing a measurement based on a measurement configuration included in the first message, the measurement configuration being associated with a secondary cell group; and releasing the measurement configuration based on a release of MR-DC.

A fourth aspect of the present invention is a method applied to a base station apparatus, the method including: notifying a terminal apparatus, for which a secondary cell group of NR is configured in MR-DC, of a release of the MR-DC, wherein notification of the release of the MR-DC causes the terminal apparatus to release a measurement configuration associated with the secondary cell group.

A fifth aspect of the present invention is an integrated circuit mounted on a terminal apparatus, the integrated circuit causing the terminal apparatus to: receive a first message; perform a measurement based on a measurement configuration included in the first message, the measurement configuration being associated with a secondary cell group; and release the measurement configuration based on a release of MR-DC.

A sixth aspect of the present invention is an integrated circuit mounted on a base station apparatus, the integrated circuit causing the base station apparatus to: notify a terminal apparatus, for which a secondary cell group of NR is configured in MR-DC, of a release of the MR-DC, wherein notification of the release of the MR-DC causes the terminal apparatus to release a measurement configuration associated with the secondary cell group.

These comprehensive or specific aspects may be implemented in a system, an apparatus, a method, an integrated circuit, a computer program, or a recording medium, or may be implemented in any combination of systems, apparatuses, methods, integrated circuits, computer programs, and recording media.

### Advantageous Effects of Invention

According to one aspect of the present invention, a terminal apparatus can efficiently perform communication by reducing complexity of protocol processing.

### BRIEF DESCRIPTION OF DRAWINGS

FIG. 1 is a schematic diagram of a communication system according to each embodiment of the present invention.

FIG. 2 is a protocol stack diagram of the user plane (UP) and the control plane (CP) of a terminal apparatus and a base station apparatus in the E-UTRA radio access layer according to each embodiment of the present invention.

FIG. 3 is a protocol stack diagram of the UP and the CP of a terminal apparatus and a base station apparatus in the NR radio access layer according to each embodiment of the present invention.

FIG. 4 is a diagram illustrating an example of a procedure for various configurations in the RRC layer in each embodiment of the present invention.

FIG. 5 is a block diagram illustrating a configuration of the terminal apparatus according to each embodiment of the present invention.

FIG. 6 is a block diagram illustrating a configuration of the base station apparatus according to each embodiment of the present invention.

FIG. 7 is an example of a processing method of the UE according to Embodiment 2 of the present invention.

FIG. 8 is an example in which the release of the E-UTRA secondary cell group in the MR-DC is activated by the NR side within the UE according to Embodiment 2 of the present invention.

FIG. 9 is an example of Abstract Syntax Notation One (ASN.1) description of information indicating that the release and the addition of the configuration for the secondary cell group are performed at the same time, included in the RRC reconfiguration message in FIG. 8, according to Embodiment 2 of the present invention.

FIG. 10 is an example of a processing method of the UE according to Embodiment 3 of the present invention.

FIG. 11 is an example in which the release of the NR secondary cell group in the MR-DC is activated by the E-UTRA side within the UE according to Embodiment 3 of the present invention.

FIG. 12 is another example in which the release of the NR secondary cell group in the MR-DC is activated by the E-UTRA side within the UE according to Embodiment 3 of the present invention.

FIG. 13 is an example in which the release of the NR secondary cell group in the MR-DC is activated within the UE according to Embodiment 3 of the present invention.

FIG. 14 is another example in which the release of the NR secondary cell group in the MR-DC is activated within the UE according to Embodiment 3 of the present invention.

### DESCRIPTION OF EMBODIMENTS

Hereinafter, embodiments of the present invention will be described in detail with reference to the drawings.

LTE (and LTE-A Pro) and NR may be defined as different RATs. NR may be defined as a technology included in LTE. LTE may be defined as a technology included in NR. LTE that is connectable to NR using Multi-RAT Dual Connectivity may be distinguished from existing LTE. LTE, in which the core network is 5GC, may be distinguished from conventional LTE, in which the core network is EPC. The present embodiment may be applied to NR, LTE, and other RATs. Terms associated with LTE and NR are used in the following description. However, the present invention may be applied to other technologies using other terms. The term “E-UTRA” in the present embodiment may be replaced with “LTE,” and the term “LTE” may be replaced with “E-UTRA”.

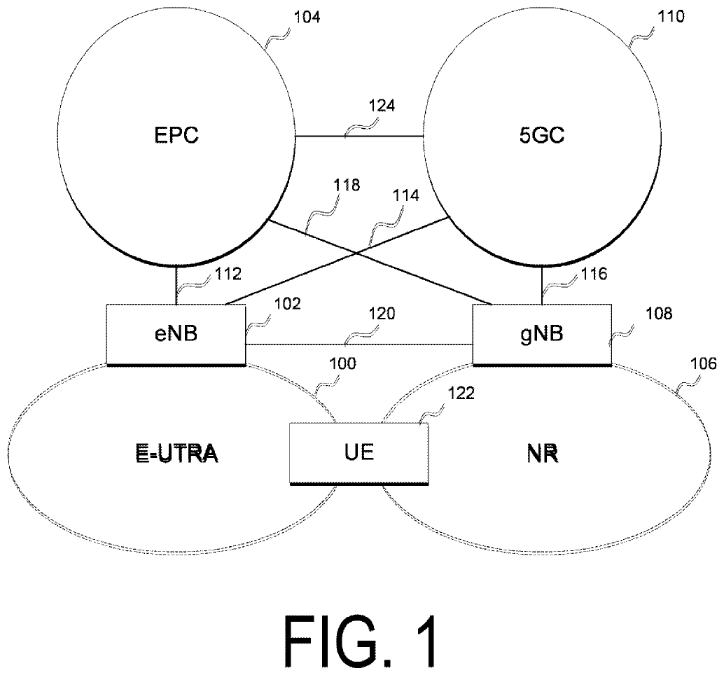

FIG. 1 is a schematic diagram of a communication system according to each embodiment of the present invention.

E-UTRA 100 is a radio access technology described in NPL 3 or the like, and includes a cell group (CG) configured in one or multiple frequency bands. An E-UTRAN Node B (eNB) 102 is a base station apparatus of E-UTRA 100. Evolved Packet Core (EPC) 104 is a core network described in NPL 14 or the like and is designed as a core network for E-UTRA 100. An interface 112 is provided between the eNB 102 and EPC 104, where there are a control plane (CP) through which control signals are transferred and a user plane (UP) through which user data is transferred.

NR 106 is a radio access technology described in NPL 9 or the like, and includes a cell group (CG) configured in one or multiple frequency bands. A gNode B (gNB) 108 is a base station apparatus of NR 106. 5GC 110 is a core network described in NPL 2 and the like, and is designed as a core network for NR 106, but may also be used as a core network for E-UTRA 100 which has a function to connect to 5GC 110. Hereinafter, E-UTRA 100 may have a function to connect to 5GC 110.

An interface 114 is provided between the eNB 102 and 5GC 110, an interface 116 is provided between the gNB 108 and 5GC 110, an interface 118 is provided between the gNB 108 and EPC 104, an interface 120 is provided between the eNB 102 and the gNB 108, and an interface 124 is provided between EPC 104 and 5GC 110. The interface 114, the interface 116, the interface 118, the interface 120, the interface 124, and the like may transfer the CP only, the UP only, or both the CP and the UP. The interface 114, the interface 116, the interface 118, the interface 120, the interface 124, and the like may not exist depending on communication systems provided by network operators.

A UE 122 is a terminal apparatus supporting NR 106 or both E-UTRA 100 and NR 106. As described in NPL 3 and/or NPL 9, in a case that the UE 122 connects to the core network via E-UTRA 100 and/or NR 106, a logical path called a Radio Bearer (RB) is established between the UE 122 and E-UTRA 100 and/or NR 106. The radio bearer used for the CP is referred to as a Signaling Radio Bearer (SRB), and the radio bearer used for the UP is referred to as a Data Radio Bearer (DRB). Each RB is assigned an RB identity (or RB ID) and is uniquely identified. The RB identity for the SRB is referred to as an SRB Identity (or SRB ID), and the RB identity for the DRB is referred to as a DRB Identity (or DRB ID).

As described in NPL 3, in a case that the connected core network of the UE 122 is EPC 104, each DRB established between the UE 122 and E-UTRA 100 and/or NR 106 is further uniquely linked to each Evolved Packet System (EPS) bearer via EPC 104. Each EPS bearer is assigned an EPS bearer identity (or ID), and is uniquely identified. Data passing through the same EPS bearer ensures the same Quality of Service (QoS).

As described in NPL 9, in a case that the connected core network of the UE 122 is 5GC 110, one or more DRBs established between the UE 122 and E-UTRA 100 and/or NR 106 are further linked to one of the Packet Data Unit (PDU) sessions established in 5GC 110. There are one or more QoS flows in each PDU session. Each DRB may be associated (mapped) with one or more QoS flows present in the linked PDU session, or may not be associated with any QoS flow. Each PDU session is identified with a PDU session identity (or ID). Each QoS flow is identified by the QoS flow identity. Data passing through the same QoS flow ensures the same QoS.

There is no PDU session and/or QoS flow for EPC 104 and there is no EPS bearer for 5GC 110. In other words, in a case that UE 122 is connected to EPC 104, the UE 122 has information of the EPS bearer, and in a case that the UE 122 is connected to 5GC 110, the UE 122 has information of the PDU session and/or QoS flow.

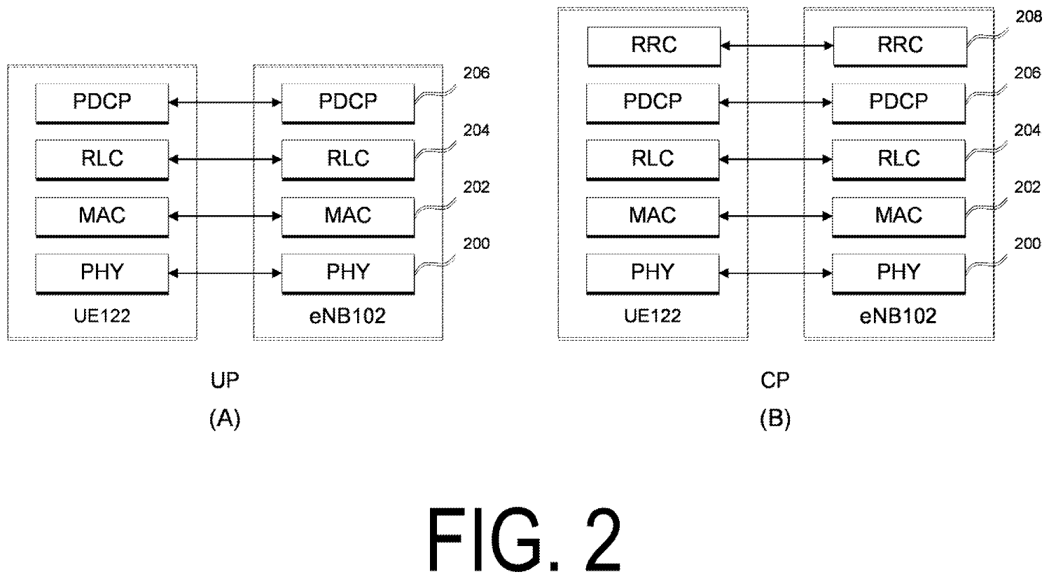

FIG. 2 is a protocol stack diagram of the UP and the CP of a terminal apparatus and a base station apparatus in the E-UTRA radio access layer according to each embodiment of the present invention.

FIG. 2(A) is a protocol stack diagram of the UP used in a case that the UE 122 communicates with the eNB 102 in E-UTRA 100.

A physical layer (PHY) 200 is a radio physical layer for providing a transmission service to a higher layer by using a physical channel. The PHY 200 is connected with a Medium Access Control layer (MAC) 202, which is a higher layer to be described below, via transport channels. Data is exchanged between the MAC 202 and the PHY 200 via the transport channels. The data is transmitted and/or received via radio physical channels between the PHYs of the UE 122 and the eNB 102.

The MAC 202 is a medium access control layer for mapping various logical channels to various transport channels. The MAC 202 is connected with a radio link control layer (RLC) 204, which is a higher layer to be described below, via logical channels. The major classifications of the logical channel depend on the type of information to be transmitted; specifically, the logical channels are classified into control channels for transmitting control information and traffic channels for transmitting user information. The MAC 202 has a function of controlling the PHY 200 in order to perform the Discontinuous Reception (DRX) and Discontinuous Transmission (DTX), functions of performing a random access procedure, functions of reporting transmit power information, functions of performing Hybrid Automatic Repeat Request (HARQ) control, and the like (NPL 7).

A Radio Link Control layer (RLC) 204 is a radio link control layer which divides (Segmentation) the data received from a Packet Data Convergence Protocol layer (PDCP) 206, which is a higher layer to be described below, and adjusts the data size such that a lower layer can properly perform data transmission. The RLC 204 also has a function of ensuring QoS required for each piece of data. In other words, the RLC 204 has a function of data retransmission control or the like (NPL 6).

A PDCP 206 is a packet data convergence protocol layer for efficiently transmitting Internet Protocol (IP) packets, which are user data, in radio segments. The PDCP 206 may have a header compression function of compressing unnecessary control information. The PDCP 206 may also have a data encryption function (NPL 5).

Note that data processed in the MAC 202, the RLC 204, and the PDCP 206 are referred to as a MAC Protocol Data Unit (PDU), an RLC PDU, and a PDCP PDU, respectively. Data delivered from a higher layer to the MAC 202, the RLC 204, and the PDCP 206 or data delivered therefrom to a higher layer are respectively referred to as a MAC Service Data Unit (SDU), an RLC SDU, and a PDCP SDU.

FIG. 2(B) is a protocol stack diagram of the CP used in a case that the UE 122 communicates with the eNB 102 and a Mobility Management Entity (MME), which is a logical node for providing a function of authentication, mobility management, and the like, in E-UTRA 100.

In addition to the PHY 200, the MAC 202, the RLC 204, and the PDCP 206, there are a Radio Resource Control layer layer (RRC) 208 and a Non-Access Stratum layer (NAS) (not explicitly shown in FIG. 2(B)) in the protocol stack of the CP. The RRC 208 is a radio link control layer that performs controls or the like of logical channels, transport channels, and physical channels, by performing processing such as establishing, re-establishing, suspending, or resuming an RRC connection, or performing reconfiguration of an RRC connection, for example, establishment, change, release or the like of a Radio Bearer (RB) and a Cell Group, as well as performs configuration of handover and measurement (measurement), and the like. The RBs may be classified into a Signaling Radio Bearer (SRB) and a Data Radio Bearer (DRB), and the SRB may be used as a path for transmitting an RRC message which is control information. The DRB may be used as a path for transmitting the user data. Each RB may be configured in the RRCs 208 of the eNB 102 and the UE 122. A portion of the RBs configured by the RLC 204 and the MAC 202 may be referred to as an RLC bearer (NPL 4). Some or all layers of the PHY 200, the MAC 202, the RLC 204, the PDCP 206, and the RRC 208 carrying signals between the UE 122 and the eNB 102 may be referred to as an Access Stratum (AS) layer, in comparison with the NAS layer carrying signals between the MME and the UE 122.

The functional classification of the MAC 202, the RLC 204, the PDCP 206, and the RRC 208 described above is an example, and some or all of the respective functions may not be implemented. Some or all of the functions of each layer may be included in another layer.

Note that an IP layer, and a Transmission Control Protocol (TCP) layer, a User Datagram Protocol (UDP) layer, an application layer, and the like that are higher layers than the IP layer, are higher layers than the PDCP layer (not illustrated). The RRC layer and the Non-Access Stratum (NAS) layer are also higher layers of the Service Data Application Protocol (SDAP) layer (not illustrated). In other words, the PDCP layer is a lower layer of the RRC layer, the NAS layer, and the IP layer, and the Transmission Control Protocol (TCP) layer, the User Datagram Protocol (UDP) layer, and the application layer that are higher layers than the IP layer.

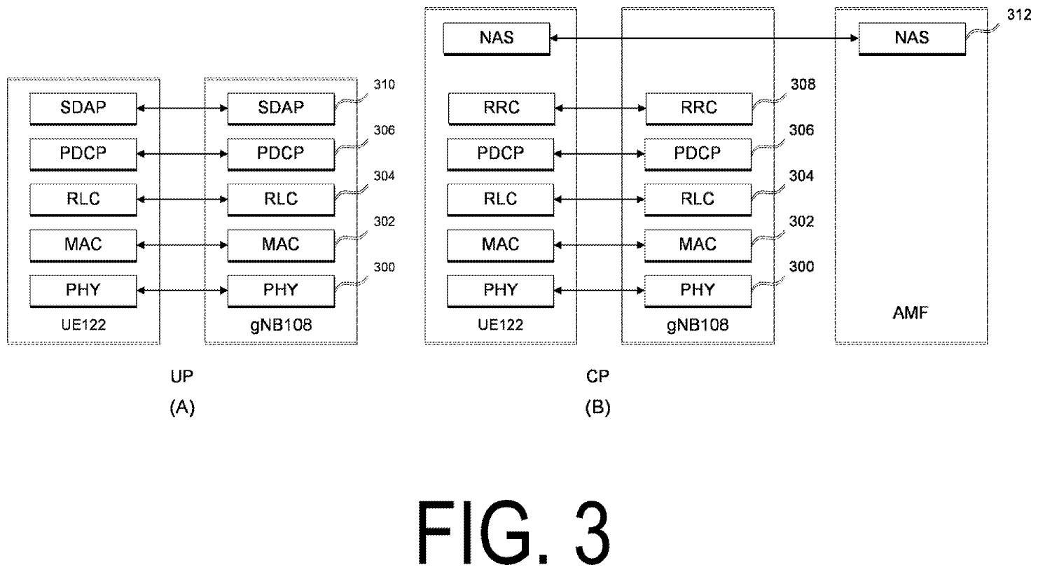

FIG. 3 is a protocol stack diagram of the UP and the CP of a terminal apparatus and a base station apparatus in the NR radio access layer according to each embodiment of the present invention.

FIG. 3(A) is a protocol stack diagram of the UP used in a case that the UE 122 communicates with the gNB 108 in NR 106.

A physical layer (PHY) 300 is a radio physical layer of NR and may provide a transmission service to a higher layer by using the physical channels. The PHY 300 may be connected with a Medium Access Control layer (MAC) 302 of a higher layer to be described below via the transport channels. Data may be exchanged between the MAC 302 and the PHY 300 via the transport channels. The data may be transmitted and/or received between the PHYs of the UE 122 and the gNB 108 via the radio physical channels.

The MAC 302 is a medium access control layer for mapping various logical channels to various transport channels. The MAC 302 may be connected with a Radio Link Control layer (RLC) 304 of a high layer to be described below via the logical channels. The classification of the logical channels depends on the types of information to be transmitted, and the logical channels may be classified into the control channels for transmitting the control information and the traffic channels for transmitting the user information. The MAC 302 may have a function of controlling the PHY 300 in order to perform the DRX and DTX, a function of performing the random access procedure, a function of reporting the transmit power information, a function of performing the HARQ control, and the like (NPL 13).

The RLC 304 is a radio link control layer which divides (Segmentation) the data received from a Packet Data Convergence Protocol Layer (PDCP) 206, which is a higher layer to be described below, and adjusts the data size such that a lower layer can properly perform data transmission. The RLC 304 may also have a function of ensuring QoS required for each piece of data. In other words, the RLC 304 may have a function of data retransmission control or the like (NPL 12).

The PDCP 306 is a packet data convergence protocol layer for efficiently transmitting IP packets (IP packets), which are user data, in radio segments. The PDCP 306 may have a header compression function of compressing unnecessary control information. The PDCP 306 may also have a data encryption function (NPL 11).

An SDAP 310 is a service data adaptation protocol layer having a function of mapping a QoS flow of a downlink transmitted from 5GC 110 to a terminal apparatus through a base station apparatus and a DRB, mapping a QoS flow of an uplink transmitted from the terminal apparatus to 5GC 110 through the base station apparatus and the DRB, and storing mapping rule information (NPL 16).

FIG. 3(B) is a protocol stack diagram of the CP used in a case that the UE 122 communicates with the gNB 108 and an Access and Mobility Management Function (AMF), which is a logical node for providing a function of authentication, mobility management, and the like, in NR 106.

In addition to the PHY 300, the MAC 302, the RLC 304, and the PDCP 306, there are an RRC Layer 308 and a NAS 312 in the protocol stack of the CP. The RRC 308 is a radio link control layer that performs controls or the like of logical channels, transport channels, and physical channels, by performing processing such as establishing, re-establishing, suspending, or resuming an RRC connection, or performing reconfiguration of an RRC connection, for example, establishment, change, release or the like of a Radio Bearer (RB) and a Cell Group, as well as performs configuration of handover and measurement (measurement), and the like. The RBs may be classified into an SRB and a DRB, and the SRB may be used as a path for transmitting an RRC message, which is control information. The DRB may be used as a path for transmitting the user data. Each RB may be configured between the RRCs 308 of the gNB 108 and the UE 122. A portion of the RBs configured by the RLC 304 and the MAC 302 may be referred to as an RLC bearer (NPL 10). Some or all layers of the PHY 200, the MAC 202, the RLC 204, the PDCP 206, and the RRC 208 carrying signals between the UE 122 and the gNB 108 may be referred to as an Access Stratum (AS) layer, in comparison with the NAS layer carrying signals between the AMF and the UE 122.

The functional classification of the MAC 302, the RLC 304, the PDCP 306, the SDAP 310, and the RRC 308 described above is an example, and some or all of the functions may not be implemented. Some or all of the functions of each layer may be included in another layer.

Note that each of the layers configured in the terminal apparatus and/or the base station apparatus may be referred to as an entity. In other words, the MAC layer, the RLC layer, the PDCP layer, the SDAP layer, and the RRC layer configured in the terminal apparatus and/or the base station apparatus may be referred to as a MAC entity, an RLC entity, a PDCP entity, an SDAP entity, and an RRC entity.

Note that, hereinafter, in each embodiment of the present invention, in order to distinguish the E-UTRA protocol and the NR protocol from each other, the MAC 202, the RLC 204, the PDCP 206, and the RRC 208 may be respectively referred to as a MAC for E-UTRA or a MAC for LTE, an RLC for E-UTRA or an RLC for LTE, a PDCP for E-UTRA or a PDCP for LTE, and an RRC for E-UTRA or an RRC for LTE. The MAC 302, the RLC 304, the PDCP 306, and the RRC 308 may also be referred to as MAC for NR, RLC for NR, RLC for NR, and RRC for NR, respectively. Alternatively, there may be descriptions using a space such as an E-UTRA PDCP or an LTE PDCP, an NR PDCP, and the like.

As also illustrated in FIG. 1, the eNB 102, the gNB 108, EPC 104, and 5GC 110 may be connected to one another via the interface 112, the interface 116, the interface 118, the interface 120, and the interface 114. Thus, the RRC 208 in FIG. 2 may be replaced with the RRC 308 in FIG. 3 to support various communication systems. The PDCP 206 in FIG. 2 may also be replaced with the PDCP 306 in FIG. 3. The RRC 308 in FIG. 3 may include the function of the RRC 208 in FIG. 2. The PDCP 306 in FIG. 3 may be the PDCP 206 in FIG. 2. In E-UTRA 100, the NR PDCP may be used as the PDCP even in a case that the UE 122 communicates with the eNB 102.

An SRB may be defined from the following SRB 0 to the SRB 3. The SRB 0 may be an SRB for an RRC message using a Common Control CHannel (CCCH) of the logical channel. The SRB 1 may be an SRB for an RRC message (which may include a piggybacked NAS message) and for an NAS message prior to the establishment of the SRB 2, and all of the Dedicated Control CHannels (DCCH) of the logical channel may be used. The SRB 2 may be an SRB for the NAS message, and all of the DCCHs of the logical channel may be used. The SRB 2 may have a lower priority than the SRB 1. The SRB 3 may be an SRB for a particular RRC message in a case that the UE 122 is configured with E-UTRA-NR Dual Connectivity (EN-DC), NG-RAN E-UTRA-NR Dual Connectivity (NGEN-DC), NR-DC, or the like, and all of the DCCHs of the logical channel may be used. Other SRBs may also be provided for other applications.

Next, the state transitions of the UE 122 in LTE will be described. The UE 122 may be in the RRC_CONNECTED state in a case that an RRC connection has been established. The UE 122 may be in the RRC_INACTIVE state in a case that the RRC connection is paused (if the UE 122 connects to 5GC). If not, the UE 122 may be the RRC_IDLE state.

Note that the UE 122 connected to EPC does not have the RRC_INACTIVE state, but pause of the RRC connection may be initiated by the E-UTRAN. In this case, in a case that the RRC connection is paused, the UE 122 retains the AS context of the UE and the identity (resumeIdentity) used for the resume to transition to the RRC_IDLE state. In a case that the UE 122 retains the AS context of the UE, the resume of the RRC connection is permitted by the E-UTRAN, and UE 122 needs to transition from the RRC_IDLE state to the RRC_CONNECTED state, the resume of the paused RRC connection may be initiated by a higher layer (e.g., the NAS layer).

That is, the definition of the pause may be different between a UE 122 connected to EPC and a UE 122 connected to 5GC. Some or all of the procedures for resume from pause may be different between a case that the UE 122 is connected to EPC (in a case that the UE 122 is paused in the RRC_IDLE state) and a case that the UE 122 is connected to 5GC (in a case that the UE is paused in the RRC_INACTIVE state).

The AS context of the UE held by the UE 122 may be information including some or all of a current RRC configuration, a current security context, a PDCP state including a RObust Header Compression (ROHC) state, a Cell Radio Network Temporary Identifier (C-RNTI) used in a source Primary Cell (PCell), a cell identity (cellIdentity), and a physical cell identity of the source PCell. Note that the AS context of the UE held by the eNB 102 and/or gNB 108 may include the same information as the AS context of the UE held by the UE 122, or may include information different from the information included in the AS context of the UE held by the UE 122.

The security context may be information including some or all of a cryptographic key at the AS level, a Next Hop parameter (NH), a Next Hop Chaining Counter parameter (NCC) used for access key derivation of the next hop, an identity of the cryptographic algorithm of the selected AS level, and a counter used for replay protection.

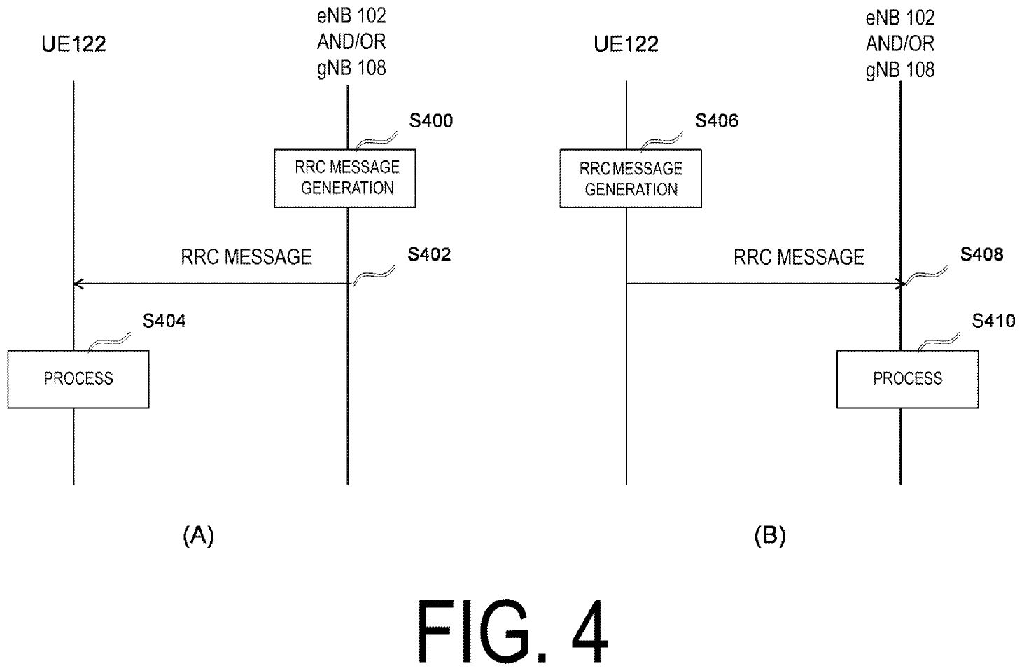

FIG. 4 is a diagram illustrating an example of a procedure for various configurations in the RRC 208 and/or the RRC 308 in each embodiment of the present invention. FIG. 4(A) is an example of a flow in a case that an RRC message is transmitted from a base station apparatus (eNB 102 and/or gNB 108) to a terminal apparatus (UE 122), and FIG. 4(B) is an example of a procedure in a case that an RRC message is transmitted from a terminal apparatus (UE 122) to a base station apparatus (eNB 102 and/or gNB 108).

In FIG. 4(A), the base station apparatus generates an RRC message (step S400). The generation of the RRC message in the base station apparatus may be performed in a case that the base station apparatus distributes System Information (SI) or paging information, or may be performed in a case that the base station apparatus determines it is necessary for a specific terminal apparatus to perform processing, for example, in a case of configuration for security, reconfiguration of the RRC connection (processing (establishment, change, release, etc.) of the radio line bearer, processing (establishment, addition, change, release, etc.) of the cell group, measurement configuration, handover configuration, etc.), release of the RRC connected state, or the like. The generation of the RRC message may be performed in order to respond to an RRC message received from a specific terminal apparatus in step S408 described later, or may be performed at a time other than these. The RRC message includes parameters for various information notifications and configurations. In the specification for RRC, such as NPL 4 or NPL 10, these parameters are referred to as fields and/or information elements, and are described using a notation called Abstract Syntax Notation One (ASN.1).

In FIG. 4(A), the base station apparatus then transmits the generated RRC message to the terminal apparatus (step S402). Next, the terminal apparatus performs a process in a case that processing such as a configuration is necessary in accordance with the received RRC message described above (step S404).

In FIG. 4(B), the terminal apparatus generates an RRC message (step S406). The generation of the RRC message in the terminal apparatus may be performed in a case that a request for the base station apparatus occurs, for example, in a case of establishment of an RRC connection according to, for example, a request from a higher layer; re-establishment of an RRC connection according to detection of radio link failure, random access failure, radio synchronization failure, or the like; resume from the RRC connection suspend according to a request from a higher layer or a Radio Access Network (RAN) paging response, or may be performed in order to respond to the RRC message received from the base station apparatus at step S402 described above, or may be performed at a time other than these. Note that in the description of each embodiment, the “RRC connection suspend” is also referred to as “pause of RRC connection”. “Resume from RRC connection suspend” is also referred to as “resume of RRC connection (from a pause state)”.

In FIG. 4(B), the terminal apparatus then transmits the generated RRC message to the base station apparatus (step S408). Next, the base station apparatus performs a process in a case that processing is necessary in accordance with the received RRC message described above (step S410).

Note that the RRC message is not limited to the examples described above, and may be generated for other purposes as described in NPL 4, NPL 10, and the like.

For example, the RRC message may be used for the configuration of Dual Connectivity (DC) or Multi-Radio Dual Connectivity (MR-DC) described in NPL 8.

The Dual Connectivity (DC) may be a technique to perform data communication using radio resources of both cell groups constituted with two base station apparatuses (nodes), namely a Master Cell Group (MCG) constituted with a Master Node (MN) and a secondary cell group (Secondary Cell Group, SCG) constituted with a secondary node (Secondary Node, SN). The MR-DC described in NPL 8 may be a technique in which cells of Radio Access Technology (RAT) of both E-UTRA and NR are grouped into cell groups for each RAT and allocated to the UE, and data communication is performed using radio resources of both the MCG and the SCG. In the MR-DC, the master node may be a base station having primary RRC functions related to the MR-DC, for example, having functions of addition of a secondary node; establishment, change, and release of an RB; addition, change, and release of a MCG; handover; and the like, and the secondary node may be a base station having some RRC functions, for example, change and release of an SCG, and the like.

In the MR-DC described in NPL 8, the RRC of the RAT on the master node side may be used for configuration of both the MCG and the SCG. For example, in E-UTRA-NR Dual Connectivity (EN-DC) (which is MR-DC in a case that the core network is EPC 104 and the master node is the eNB 102 (also referred to as an extended eNB 102), or NG-RAN E-UTRA-NR Dual Connectivity (NGEN-DC), which is MR-DC in a case that the core network is 5GC 110 and the master node is eNB 102), an RRC message of E-UTRA described in NPL 4 may be transmitted and/or received between the eNB 102 and the UE 122. In this case, the RRC message may include not only configuration information of LTE (E-UTRA), but also configuration information of NR described in NPL 10. The RRC message transmitted from the eNB 102 to the UE 122 may be transmitted to the UE 122 from the eNB 102 via the gNB 108. The configuration of the RRC message may be used in E-UTRA/5GC (option 5 described in NPL 17), which is non-MR-DC in which the eNB 102 (extended eNB) uses 5GC as the core network. Hereinafter, the EN-DC may include the NGEN-DC unless stated otherwise.

In contrast, in the MR-DC described in NPL 8, an RRC message of NR described in NPL 10 may be transmitted and/or received between the gNB 108 and the UE 122 in NR-E-UTRA Dual Connectivity (NE-DC), which is one of MR-DC in a case that the core network is 5GC 110 and the master node is the gNB 108. In this case, the RRC message may include not only configuration information of NR, but also configuration information of LTE (E-UTRA) described in NPL 4. The RRC message transmitted from the gNB 108 to the UE 122 may be transmitted to the UE 122 from the gNB 108 via the eNB 102. In NR Dual Connectivity (NR-DC), which is MR-DC in a case that the core network is 5GC 110 and both the master node and the secondary node are the gNB 108, an RRC message of NR described in NPL 10 may be transmitted and/or received between the gNB 108 and the UE 122. The RRC message transmitted from the gNB 108 to the UE 122 may be transmitted to the UE 122 from the gNB 108 via another gNB 108. NR-DC may also be expressed as NN-DC, N2-DC, NR2-DC, or NRNR-DC.

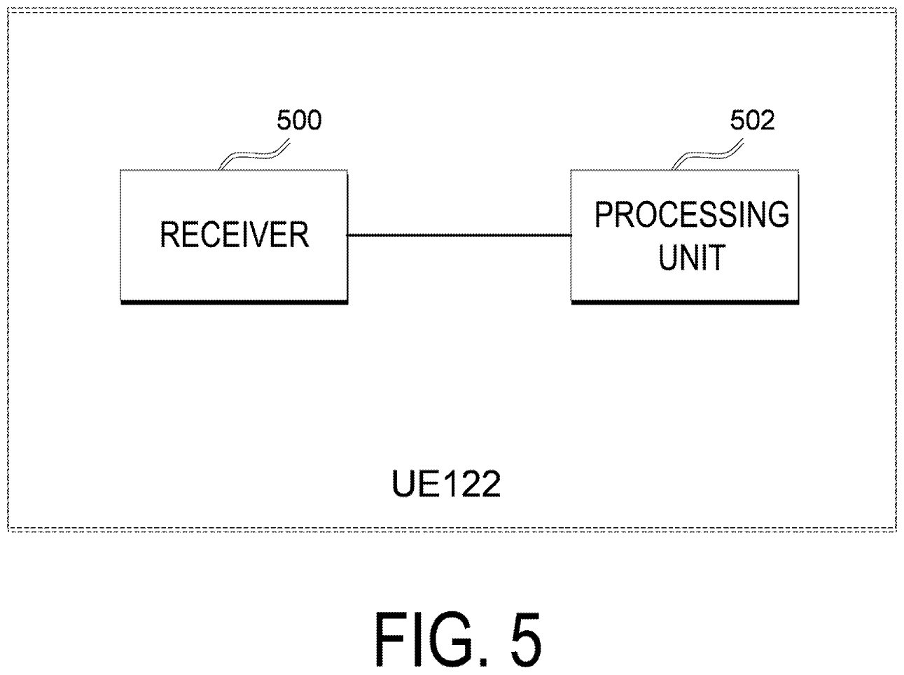

FIG. 5 is a block diagram illustrating a configuration of the terminal apparatus (UE 122) according to each embodiment of the present invention. Note that FIG. 5 illustrates only the main components closely related to an aspect of the present invention in order to avoid complexity of description.

The UE 122 illustrated in FIG. 5 includes a receiver 500 configured to receive an RRC message or the like from the eNB 102 and/or the gNB 108, and a processing unit 502 configured to perform processing according to configuration information, such as various types of Information Elements (IEs), and/or various fields, and/or various conditions included in the received message. The processing unit 502 may perform processing to trigger a request or an indication from the MCG side to the SCG side within the UE 122 configured with DC. For example, within the UE 122 configured with MR-DC, the processing unit 502 may perform processing to trigger a request or an indication from the E-UTRA side to the NR side in the NGEN-DC or the EN-DC described in NPL 8, for example, or from the NR side to the E-UTRA side in the NE-DC described in NPL 8, for example. The processing unit 502 may perform processing activated from the MCG side on the SCG side within the UE 122 configured with DC. For example, the processing unit 502 may perform processing activated from the E-UTRA side on the NR side in the NGEN-DC or the EN-DC described in NPL 8, for example, or the processing unit 502 may perform processing activated from the NR side on the E-UTRA side in the NE-DC described in NPL 8, for example. Note that “the MR-DC is configured” may refer to “the MR-DC is processed”, or may refer to “the MR-DC is operated”. Note that the NR side and the E-UTRA side here may be the NR RRC and the E-UTRA RRC, respectively.

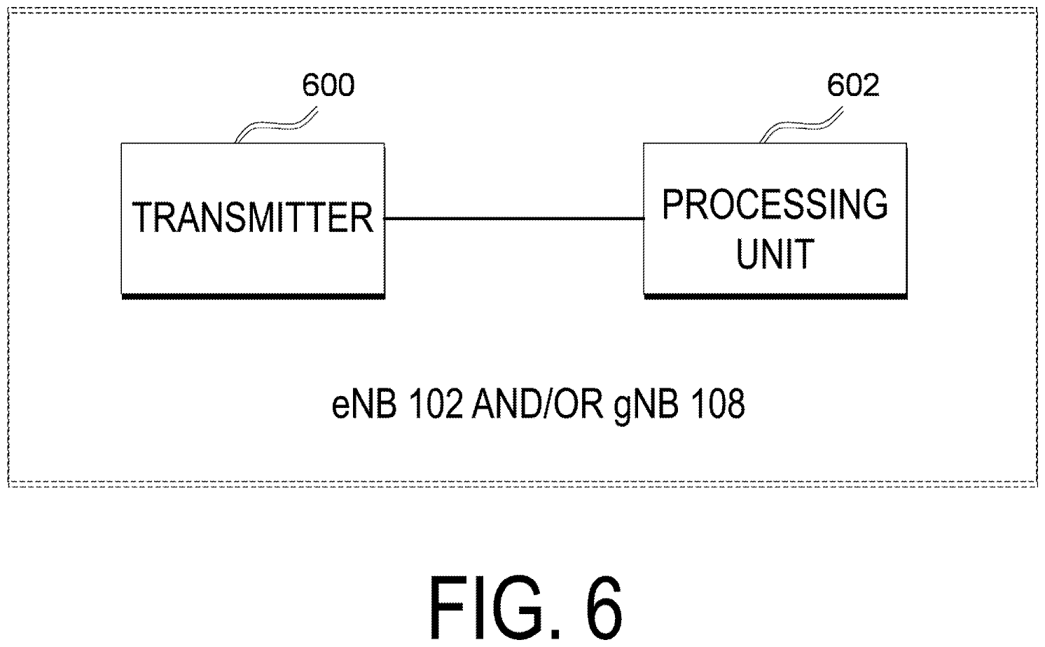

FIG. 6 is a block diagram illustrating a configuration of the base station apparatus (eNB 102 and/or gNB 108) according to each embodiment of the present invention. Note that FIG. 6 illustrates only the main components closely related to an aspect of the present invention in order to avoid complexity of description.

The eNB 102 and/or the gNB 108 illustrated in FIG. 6 includes a transmitter 600 configured to transmit an RRC message or the like to the UE 122, and a processing unit 602 configured to cause the processing unit 502 of the UE 122 to perform processing by creating and transmitting an RRC message including the configuration information to the UE 122, such as various Information Elements (IE), and/or various fields, and/or various conditions.

### Embodiment 1

Embodiment 1 of the present invention will be described. Embodiment 1 of the present invention will be described assuming MR-DC in which the MCG side is NR and the SCG side is NR, but the present invention is not limited thereto, and may be applied to other MR-DC. Note that each embodiment of the present invention may be implemented in combination with one or more other embodiments.

Measurements will be described. In the following description, an example in which the gNB 108 uses an RRC message (RRC signaling) of NR is described, but this is not a limitation, and similar processing may be performed by the eNB 102 using an RRC message (RRC signaling) of LTE. Note that the information included in the message and/or the configuration of the message is an example and is not limited thereto.

The gNB 108 transmits measurement configuration information elements (also referred to as measurement configuration) to the UE 122 by using an RRC reconfiguration (RRCReconfiguration) message of RRC signaling (radio resource control signal) (included in the RRC reconfiguration message). The UE 122 performs measurements, event assessments, and measurement reports on serving cells and neighbor cells (including listed cell and/or detected cells) according to information included in the reported measurement configuration. The listed cells are cells listed in measurement objects (cells notified as a neighbor cell list from the gNB 108 to the UE 122). The detected cells are cells that are detected by the UE 122 at the frequency and subcarrier spacing indicated by the measurement objects but not listed in the measurement objects (cells detected by the UE 122 itself that are not notified as the neighbor cell list).

The UE 122 may have a variable VarMeasConfig to hold the notified measurement configuration. The UE 122 may have a variable VarMeasReportList to hold measurement information consistent with the reporting condition. In MR-DC, the UE 122 may individually have a variable VarMeasConfig for holding a first measurement configuration configured by the MCG (or for the MCG, or linked with the MCG) and a variable VarMeasReportList for holding the measurement information consistent with the reporting condition of the first measurement configuration, and a variable VarMeasConfig for holding a second measurement configuration configured by the SCG (or for the SCG, or liked with the SCG) and a variable VarMeasReportList for holding the measurement information consistent with the reporting condition of the second measurement configuration. In MR-DC, the UE 122 may individually have (manage) a timer controlled by the measurement configuration configured by the MCG (or for the MCG, or linked with the MCG) (for example, a timer used to periodically report measurement information based on the measurement configuration configured by the MCG or a timer T321 used for the measurement of the global identity, and the like), and a timer controlled by the measurement configuration configured by the SCG (or for the SCG, or liked with the SCG) (for example, a timer used to periodically report measurement information based on the measurement configuration configured by the SCG or a timer T321 used for the measurement of the global identity, and the like). Here, the timer names used for the same purpose in the MCG and the SCG may be the same name or different names. In a case that multiple SCGs are configured, the variable VarMeasConfig may be held for each SCG, or one variable VarMeasConfig may be held for all of the SCGs. The measurement configuration notified from the gNB 108 may be notified distinguished between the measurement configuration of the MCG and the measurement configuration of the SCG. For example, (A) the first RRC reconfiguration message may include the measurement configuration for the MCG, the field indicating information on the SCG of the MR-DC included in the first RRC reconfiguration message may include an encapsulated RRC reconfiguration message (second RRC reconfiguration message) of the SCG, and the second RRC reconfiguration message may include the measurement configuration for the SCG. At this time, the first RRC reconfiguration message notifying the measurement configuration of the MCG and the first RRC reconfiguration message notifying the measurement configuration of the SCG may be the same RRC reconfiguration message, or may be different RRC reconfiguration messages notified at different timings. Alternatively, (B) the measurement configuration of the MCG may be notified by the SRB 1, and the measurement configuration of the SCG may be notified by the SRB 3. Either or both of (A) and (B) may be considered for identification of the measurement configuration of the MCG and the measurement configuration of the SCG. Alternatively, the identification of the measurement configuration of the MCG and the measurement configuration of the SCG may be performed based on other information.

The measurements have three types (intra-frequency measurements, inter-frequency measurements, and inter-radio access technology measurements (inter-RAT measurements)). The intra-frequency measurements are measurements on the downlink frequency of the serving cell. The inter-frequency measurements are measurements on frequencies different from the downlink frequency of the serving cell. The inter-RAT measurements are measurements on radio technologies (e.g., UTRA, Global System for Mobile Communications (GSM) Enhanced Data for Global Evolution (EDGE) Radio Access Network (RAN) (or GERAN), Code Division Multiple Access 2000 (CDMA2000), E-UTRA, etc.) different from the radio technology of the serving cell (e.g., NR).

The measurement configuration may include some or all of an addition and/or modification list of measurement identities (measId), a removal list of measurement identities, an addition and/or modification list of measurement objects, a removal list of measurement objects, an addition and/or modification list of reporting configurations, a removal list of reporting configurations, a quantity configuration (quantityConfig), a measurement gap configuration (measGapConfig), and a serving cell quality threshold (s-Measure) configuration.

Quantity Configuration (quantityConfig)

The quantity configuration (quantityConfig) specifies a Layer 3 (L3) filtering coefficient in a case that the measurement objects are NR and/or E-UTRA measurement objects. The L3 filtering coefficient defines a ratio of the latest measurement result and the past filtering measurement result. The filtering result is used for event assessment in the UE 122.

Measurement Gap Configuration (measGapConfig)

The measurement gap configuration (measGapConfig) is utilized for the configuration of the measurement gap pattern or for the control of the activation/deactivation of the measurement gap. The measurement gap configuration may be independently configured for each cell, each cell group, each component carrier, each serving cell, or each predefined frequency range.

Serving Cell Quality Threshold (s-Measure)

The serving cell quality threshold (s-Measure) represents a threshold value for the quality of the serving cell and is utilized to control whether or not the UE 122 needs to perform a measurement. The serving cell quality threshold (s-Measure) is configured as a value for reference signal received power (RSRP).

Measurement Identity (measId)

Here, the measurement identity (measId) is utilized to link the measurement objects and the reporting configurations, specifically, link the measurement object identity (measObjectId) and the reporting configuration identity (reportConfigId). The measurement identity (measId) is associated with one measurement object identity (measObjectId) and one reporting configuration identity (reportConfigId). The measurement configuration can add, modify, or delete a relationship of measurement identities (measId), measurement objects, and reporting configurations.

The removal list of measurement identities included in the measurement configuration includes a list of measurement identities, and the UE 122 performs the following processes (A) to (C) for each measurement identity included in the removal list of the measurement identities. (A) The entry of this measurement identity is deleted from the variable VarMeasConfig of the cell group of interest in the measurement configuration. (B) If included, the entry of the measurement report for this measurement identity is deleted from the variable VarMeasReportList of the cell group of interest in the measurement configuration. (C) The timer used for the periodical reporting for this measurement identity or the timer T321 is stopped in a case that the timer has started, and the associated information for this measurement identity is reset. Note that the timer T321 is a timer that starts in a case that a measurement configuration including a reporting configuration for the purpose of measuring the cell global identity is received, and the procedure of the measurement report is initiated in a case that the timer expires. The timer is stopped in a case that the removal list of the reporting configuration to be described later includes an identity of the reporting configuration for the purpose of measuring the cell global identity, or in a case that the detected cell does not broadcast the SIB 1. The timer T321 may be separate timers between the MCG and the SCG, may be a common timer, or may be a timer used only in the MCG or the SCG. In the case of separate timers, the UE 122 may determine which timer to use based on the cell group of interest in the measurement configuration. The timer used for the periodical reporting may be separate timers between the MCG and the SCG, may be a common timer, or may be a timer used only in the MCG or the SCG. In the case of separate timers, the UE 122 may determine which timer to use based on the cell group of interest in the measurement configuration. For example, depending on the purposes, the timer used for periodical reporting which is useful for mobility and detecting secondary cells may be held by the UE 122 as timers separate between the MCG and the SCG, and the timer T321 for the measurement of the cell global identity which is primarily used for network optimization may be held by the UE 122 as the timer only used in the MCG. Alternatively, the UE 122 may operate assuming that a measurement configuration involving the start of the timer T321 is not configured at the same time in both the MCG and the SCG. This can prevent the design of the UE 122 from becoming complex.

The addition and/or modification list of measurement identities included in the measurement configuration includes a list of measurement identities, and the UE 122 performs the following processes (A) to (C) for each measurement identity included in the addition and/or modification list of the measurement identities. (A) In a case that an entry of a measurement identity that is consistent with this measurement identity is present in the list of measurement identities included in the variable VarMeasConfig of the cell group of interest in the measurement configuration, the entry is replaced by the value received for this measurement identity (measId). Otherwise, a new entry for this measurement identity is added to the variable VarMeasConfig of the cell group of interest in the measurement configuration. (B) If included, the measurement report entry for this measurement identity is deleted from the variable VarMeasReportList of the cell group of interest in the measurement configuration. (C) The timer used for the periodical reporting for this measurement identity or the timer T321 is stopped in a case that the timer has started, and the associated information for this measurement identity is reset.

The removal list (measObjectToRemoveList) of the measurement objects included in the measurement configuration is a field including specified measurement object identities (measObjectId) and information for deleting the measurement objects corresponding to the specified measurement object identities (measObjectId). At this time, all of the measurement identities (measId) of the cell group of interest in the measurement configuration associated with the specified measurement object identities (measObjectId) may be deleted. The field can specify multiple measurement object identities (measObjectId) at the same time.

The addition and/or modification list (measObjectToAddModList) of the measurement objects included in the measurement configuration is a field including information to modify the measurement objects specified by the measurement object identities (measObjectId) or add the measurement objects specified by the measurement object identities (measObjectId). The field can specify multiple measurement object identities (measObjectId) at the same time.

The removal list (reportConfigToRemoveList) of the reporting configuration included in the measurement configuration is a field including specified reporting configuration identities (reportConfigId) and information to delete the reporting configurations corresponding to the specified reporting configuration identities (reportConfigId). At this time, all measurement identities (measId) associated with the specified reporting configuration identities (reportConfigId) are deleted. This command can specify multiple reporting configuration identities (reportConfigId) at the same time.

The addition and/or modification list (reportConfigToAddModList) of the reporting configurations is a field including information to modify the reporting configurations specified by the reporting configuration identities (reportConfigId) or add reporting configurations specified by the reporting configuration identities (reportConfigId). This field can specify multiple reporting configuration identities (reportConfigId) at the same time.

The removal list of the measurement identities (measIdToRemoveList) is a command to delete the specified measurement identities (measId). At this time, the measurement object identities (measObjectId) and the reporting configuration identities (reportConfigId) associated with the specified measurement identities (measId) are maintained without being deleted. This command can specify multiple measurement identities (measId) at the same time.

The addition and/or modification list (measIdToAddModifyList) of the measurement identities is a command to modify the specified measurement identities (measId) to be associated with the specified measurement object identities (measObjectId) and the specified reporting configuration identities (reportConfigId), or add the specified measurement identities (measId) by associating the specified measurement object identities (measObjectId) and the specified reporting configuration identities (reportConfigId) with the specified measurement identities (measId). This command can specify multiple measurement identities (measId) at the same time.

### Measurement Objects

Measurement objects are configured (defined) for each RAT and frequency. Note that in a case that the RAT is NR, the measurement objects may be configured for each frequency and subcarrier spacing. Reporting configurations may be defined for NR and for RATs other than NR.

The measurement objects may include a measurement object NR (measObjectNR) in which the measurement object associated with the measurement object identity (measObjectId) is NR, and a measurement object E-UTRA (measObjectEUTRA) in which the measurement object is E-UTRA. The measurement objects may include some or all of a measurement object UTRA (measObjectUTRA) in which the measurement object is UTRA, a measurement object GERAN (measObjectGERAN) in which the measurement object is GERAN, a measurement object CDMA2000 (measObjectCDMA2000) in which the measurement object is CDMA2000, and a measurement object Wireless Local Area Network (WLAN) (measObjectWLAN) in which the measurement object is WLAN.

The measurement object identities (measObjectId) are identities used to identify configurations of measurement objects. As described above, the configuration of the measurement objects is defined for each radio access technology (RAT) and frequency, and further for each subcarrier spacing in NR. The measurement objects may be separately specified for E-UTRA, UTRA, GERAN, and CDMA2000. The measurement object NR (measObjectNR), which is a measurement object for NR, defines the information to be applied to serving cells and neighbor cells of NR. Note that which measurement object indicated by which measurement object identity corresponds to a serving cell may be indicated by an information element (e.g., serving cell configuration) included in an RRC message included in the measurement configuration and/or an RRC message not included in the measurement configuration.

The measurement object NR (measObjectNR) includes some or all of frequency information (ssbFrequency) of a Sychronization Signal Block (SSB) including a synchronization signal, subcarrier spacing (ssbSubcarrierSpacing) of the SSB, information on the list of cells to be measured, information on the blacklist that is excluded from the measurement, and information on the whitelist to be measured.

The information on the list of cells to be measured includes event assessment or information on the cells of interest in the measurement report. The information on the list of cells to be measured includes a physical cell identity (physical cell ID), a cell-specific offset (cellIndividualOffset, indicating a measurement offset value applied to the neighbor cell), and the like.

Reporting Configurations The reporting configurations include a reporting configuration NR (reportConfigNR) associated with the reporting configuration identity (reportConfigId), and the like.

The reporting configuration identity (reportConfigId) is an identity used to identify a reporting configuration related to the measurement. The reporting configurations for measurements may be defined for NR and for RATs other than NR (some or all of UTRA, GERAN, CDMA2000, and E-UTRA), as described above. The reporting configuration NR (reportConfigNR), which is the reporting configuration for NR, defines a triggering criteria of an event utilized for reporting of a measurement in NR.

The reporting configuration NR (reportConfigNR) may include some or all of an event identity (eventId), a trigger quantity (triggerQuantity), hysteresis, a trigger time (timeToTrigger), a report quantity (reportQuantity), number of maximum report cells (maxReportCells), a report interval (reportInterval), and a report amount (reportAmount).

Next, the reporting configuration NR (reportConfigNR) will be described. The event identity (eventId) is used to select criteria related to event-triggered reporting. Here, the event triggered reporting is a method to report a measurement in a case that event triggering criteria are satisfied. In addition, there is also event triggered periodic reporting that reports measurements only a certain number of times at regular intervals in a case that event triggering criteria are satisfied.

The event triggering criteria may include at least six types described below. In a case that the event triggering criteria specified by an event identity (eventId) are satisfied, then the UE 122 performs a measurement report for the gNB 108. The trigger quantity (triggerQuantity) is the quantity utilized to evaluate event triggering criteria. That is, reference signal received power (RSRP) or reference signal received quality (RSRQ) is specified. That is, the UE 122 performs measurements of synchronization signals of the downlink using the quantity specified by this trigger quantity (triggerQuantity), and determines whether or not the event triggering criteria specified by the event identity (eventId) are satisfied. The hysteresis is a parameter utilized in event triggering criteria. The trigger time (timeToTrigger) indicates a period in which event triggering criteria should be satisfied. The report quantity (reportQuantity) indicates the quantity reported in the measurement report. Here, the quantity specified by the trigger quantity (triggerQuantity) or the reference signal received power (RSRP) or reference signal received quality (RSRQ) are specified. The number of maximum report cells (maxReportCells) indicates the maximum number of cells included in the measurement report. The report interval (reportInterval) is used for periodical reporting or event triggered periodic reporting and is reported periodically for each interval indicated by the report interval (reportInterval). The report amount (reportAmount) defines the number of times to perform periodical reporting as necessary.

Note that threshold parameters and offset parameters (a1_Threshold, a2_Threshold, a3_Offset, a4_Threshold, a5_Threshold1, a5_Threshold2, a6_Offset, c1_Threshold, c2_Offset) utilized for event triggering criteria may be notified to the UE 122 together with the event identity (eventId) in the reporting configuration NR (reportConfigNR).

Event Triggering Criteria

Multiple event triggering criteria are defined for a measurement report, each of which has subscription criteria and withdrawal criteria. That is, the UE 122 that satisfies the subscription criteria for the event specified from the gNB 108 transmits a measurement report to the gNB 108. The UE 122 that satisfies the withdrawal criteria for the event specified from the gNB 108 transmits a measurement report to the gNB 108 in a case that the UE 122 is configured to trigger the report in a case that the withdrawal criteria for withdrawing from the gNB 108 are satisfied (in a case that the reporting configuration includes reportOnLeave).

Multiple triggering criteria for events that are used for reporting measurements in RATs other than NR are defined in the reporting configuration InterRAT (reportConfigInterRAT), which is a reporting configuration for RATs other than NR. For example, in a case that the measurement result of a neighbor cell (other RAT) is better than a threshold value b1_Threshold configured for each RAT after application of each parameter, an event B1 occurs. In a case that the measurement result of the PCell is worse than a threshold value b2_Threshold1 after application of each parameter and the measurement result of a neighbor cell (other RAT) is better than a threshold value b2_Threshold2 configured for each RAT after application of each parameter, an event B2 occurs.

Note that the gNB 108 may or may not notify the serving cell quality threshold (s-Measure). In a case that the serving cell quality threshold (s-Measure) is configured to the UE 122 by the gNB 108, and the quality (RSRP value) after the Layer 3 filtering of the PCell, which is the serving cell, is lower than the serving cell quality threshold (s-Measure), the measurement of the frequency indicated by the measurement object and the neighbor cell of RAT is performed. Meanwhile, in a case that the serving cell quality threshold (s-Measure) is not configured to the UE 122 by the gNB 108, the UE 122 performs a measurement of a neighbor cell regardless of the quality of the serving cell (RSRP value).

Measurement Result

The UE 122 may initiate the procedure of measurement report in a case that event triggering criteria are satisfied, in a case that the first measurement result of the periodical reporting is available, in a case that the timer of the periodical reporting or the timer T321 expires, or the like. The procedure purpose of the measurement report is to transfer a measurement report from the UE 122 to the network. The measurement report includes a measurement result. The measurement result is configured for each measurement identity triggered by the procedure of measurement report.

The measurement result may include a measurement identity (measId), a list of serving measurement object measurement results (measResultServingMO), and a neighbor cell measurement result (measResultNeighCellNR). The neighbor cell measurement result may include any of a list of measurement results of NR and a list of measurement results of E-UTRA. The measurement results of NR and the measurement results of E-UTRA include some or all of physical cell identities, measurement results of cells, and information of the cell global identity. The serving measurement object measurement result (measResultServingMO) is a measurement result of the measurement object associated with the serving cell, and may include some or all of the identity of the serving cell, the measurement result of the serving cell, and the measurement result of the best neighbor cell.

In the procedure of measurement report, a measurement result as described above is set for each measurement identity for which the procedure of measurement report is triggered, and in a case that the UE 122 is configured with the EN-DC, a message of the measurement report including the measurement result is submitted to a lower layer through the SRB 3 for transmission and the procedure is ended in a case that the SRB 3 is configured, or a message of the measurement report is encapsulated (embedded) in the RRC message of E-UTRA and submitted to a lower layer through the MCG of E-UTRA in a case that the SRB 3 is not configured. In a case that the UE 122 is configured with NR-DC and the measurement configuration that triggered this measurement report is associated with the SCG, a message of the measurement report including the measurement result is submitted to a lower layer through the SRB 3 for transmission and the procedure is ended in a case that the SRB 3 is configured, or a message of the measurement report is encapsulated (embedded) in the RRC message of the MCG of NR and submitted to a lower layer through the MCG of NR in a case that the SRB 3 is not configured.

As described above, in the present embodiment, appropriate measurements can be made for each cell group by configuring the measurements in consideration of the cell group of interest in the measurement configuration of the UE 122.

### Embodiment 2

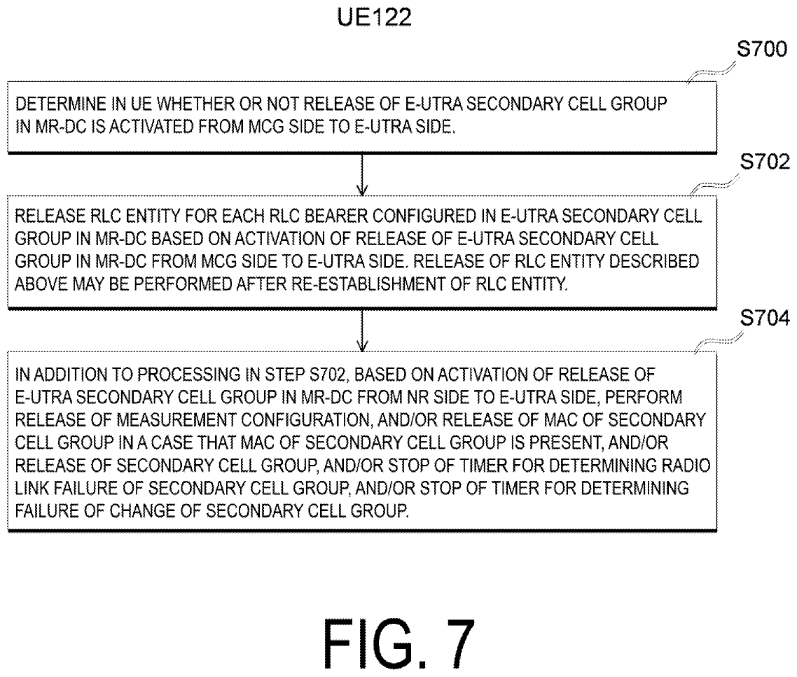

Embodiment 2 of the present invention will be described with reference to FIGS. 7 to 9. In the present embodiment, an example of a method for activating the release of the SCG side from the MCG side of the terminal apparatus to the SCG side in a case that some or all of the configurations of the SCG side are required to be released in the terminal apparatus configured with MR-DC described in NPL 8 will be described. Embodiment 2 of the present invention will be described assuming NE-DC which is MR-DC in which the MCG side is NR and the SCG side is E-UTRA in particular. However, the present invention may be applied to other MR-DC or DC having the MCG and the SCG of the same RAT (E-UTRA, NR, and the like).

FIG. 7 is an example of the processing method of the UE 122 according to Embodiment 2 of the present invention.

The processing unit 502 of the UE 122 determines whether or not the release of the E-UTRA Secondary Cell Group (SCG) in the MR-DC is activated from the MCG side to the E-UTRA side, which is the SCG side within the UE 122 (step S700). Note that in step S700, the MR-DC may be NE-DC. The release of the E-UTRA secondary cell group in the MR-DC may be referred to as release of the NE-DC. The E-UTRA secondary cell group may simply be referred to as a secondary cell group. The MCG may be NR.

Next, the processing unit 502 of the UE 122 releases the RLC entity for each RLC bearer configured in the E-UTRA secondary cell group in the MR-DC, based on activation of the release of the E-UTRA secondary cell group in the MR-DC from the MCG side to the E-UTRA side within the UE 122. The release of the RLC entity described above may be performed after re-establishment of the RLC entity (step S702). Note that “for each RLC bearer” described above may be referred to as or may be noted with “for each logical channel or for each logical channel identity”. The MCG may be NR.

In addition to the processing in step S702 described above, the processing unit 502 of the UE 122 may perform, based on activation of the release of the E-UTRA secondary cell group in the MR-DC from the MCG side to the E-UTRA side within the UE 122, the release of the measurement configuration configured by the E-UTRA secondary cell group, and/or the release of the MAC of the secondary cell group in a case that the MAC of the secondary cell group is present, and/or the release of the secondary cell group, and/or the stop of the timer for determining the radio link failure of the secondary cell group, and/or the stop of the timer for determining failure of the change of the secondary cell group (step S704). The MCG may be NR.

Note that the activation of the release of the E-UTRA secondary cell group in the MR-DC from the MCG side to the E-UTRA side within the UE 122 described above may be activated, for example, based on the MR-DC being configured, by determining whether or not the MR-DC is configured in a case of requesting the re-establishment of the RRC connection (RRC Re-establishment), for example in the NR side (not illustrated). Note that “the MR-DC is configured” may refer to “the MR-DC is processed”, or may refer to “the MR-DC is operated”. “Determining whether or not the MR-DC is configured” described above may be referred to as “determining whether or not the NE-DC is configured”. “May be activated based on the MR-DC being configured” described above may be referred to as “may be activated based on the NE-DC being configured”.

The activation of the release of the E-UTRA secondary cell group in the MR-DC from the MCG side to the E-UTRA side within the UE 122 described above may be activated, for example, based on the MR-DC having being configured, by determining whether or not the MR-DC has been configured during the RRC connection suspend in a case that the resume from the RRC connection suspend is requested on the NR side (not illustrated). Note that, in each embodiment, “the MR-DC was configured” may refer to “the MR-DC was processed”, or may refer to “the MR-DC was operated”. “Determining whether or not the MR-DC was configured” described above may be referred to as “determining whether or not the NE-DC was configured”. “May be activated based on the MR-DC having been configured” described above may be referred to as “may be activated based on the NE-DC having been configured”.

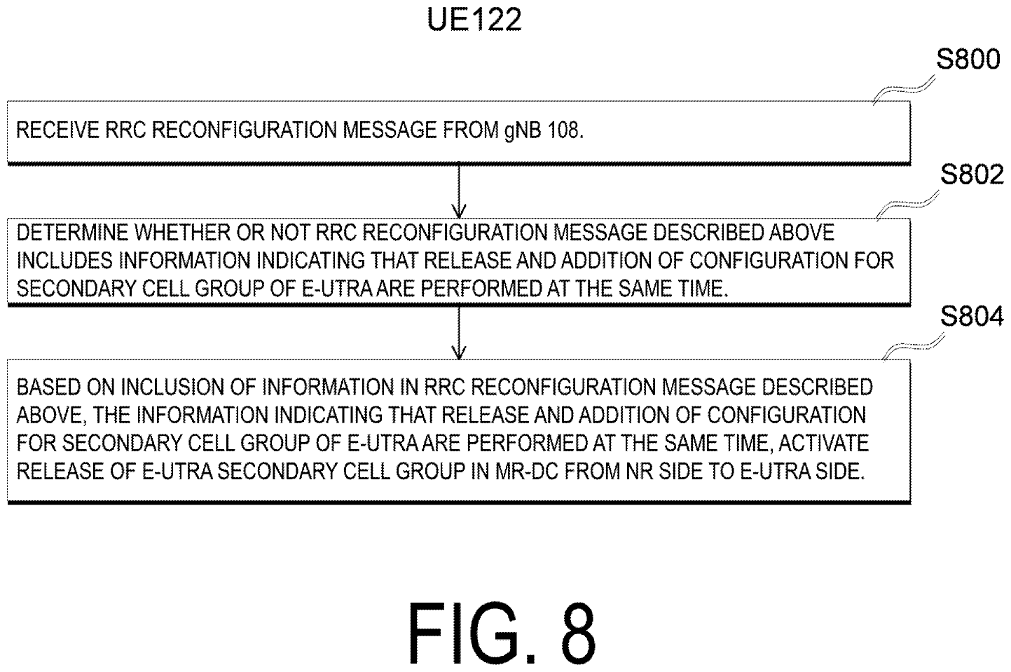

The activation of the release of the E-UTRA secondary cell group in the MR-DC from the NR side to the E-UTRA side within the UE 122 described above may be activated based on other events. FIG. 8 is an example in which the release of the E-UTRA secondary cell group in the MR-DC is activated by the NR side within the UE 122 according to Embodiment 2 of the present invention.

The processing unit 602 of the gNB 108 generates an RRC reconfiguration message, which is an RRC message for causing the UE 122 to perform the reconfiguration processing of the RRC connection, and transmits the RRC reconfiguration message to the UE 122 from the transmitter 600 (not illustrated). The receiver 500 of the UE 122 receives the RRC reconfiguration message from the gNB 108 (step S800). Note that the UE 122 may receive the RRC reconfiguration message from the eNB 102.

Next, the processing unit 502 of the UE 122 determines whether or not the RRC reconfiguration message received in step S800 includes information indicating that the release and the addition of the configuration for the SCG of E-UTRA are performed at the same time (step S802). Note that “determining whether or not the information indicating that the release and the addition of the configuration for the SCG of E-UTRA are performed at the same time is included” described above may be referred to as “determining whether the information indicating that the release and the addition of the configuration for the SCG of E-UTRA are performed at the same time is true or false”. True/false described above may be replaced with other description of conflicting meanings, such as enable/disable, on/off, I/O, etc. “The release and the addition of the configuration for the SCG of E-UTRA are performed at the same time” described above may be referred to as “the release and the addition of all the configurations for the SCG of E-UTRA are performed at the same time”. The “configuration for the SCG of the E-UTRA” and “all the configurations for the SCG of the E-UTRA” described above may be configured by E-UTRA, or may be configured by an RRC message of E-UTRA.

Next, the processing unit 502 of the UE 122 activates the release of the E-UTRA secondary cell group in the MR-DC from the NR side to the E-UTRA side, based on inclusion of information in the RRC reconfiguration message described above, the information indicating that the release and the addition of the configuration for the secondary cell group of E-UTRA are performed at the same time (step S804). Note that the MR-DC in step S804 may be NE-DC. Note that “based on inclusion of the information indicating that the release and the addition of the configuration for the SCG of E-UTRA are performed at the same time” described above may be referred to as “based on a fact that the information indicating that the release and the addition of the configuration for the SCG of E-UTRA are performed at the same time is true”. True described above may be replaced with other expressions, such as enable, on, 1, etc., meaning that this information is valid. “The information indicating that the addition and the release of the configuration for the SCG of E-UTRA are performed at the same time” may be included in a case that full configuration is necessary on the E-UTRA SCG side, or may mean that this information is valid by being configured to true, enable, on, 1, and the like.

Note that the example of the process illustrated in FIG. 8 may be used for not only the release of the E-UTRA secondary cell group in the MR-DC, but also for the release of the NR secondary cell group in the NR-DC. In a case that the release of the NR secondary cell group in the NR-DC is performed, the above-described “configuration for the SCG of E-UTRA” may be referred to as “a configuration for the SCG of NR”.

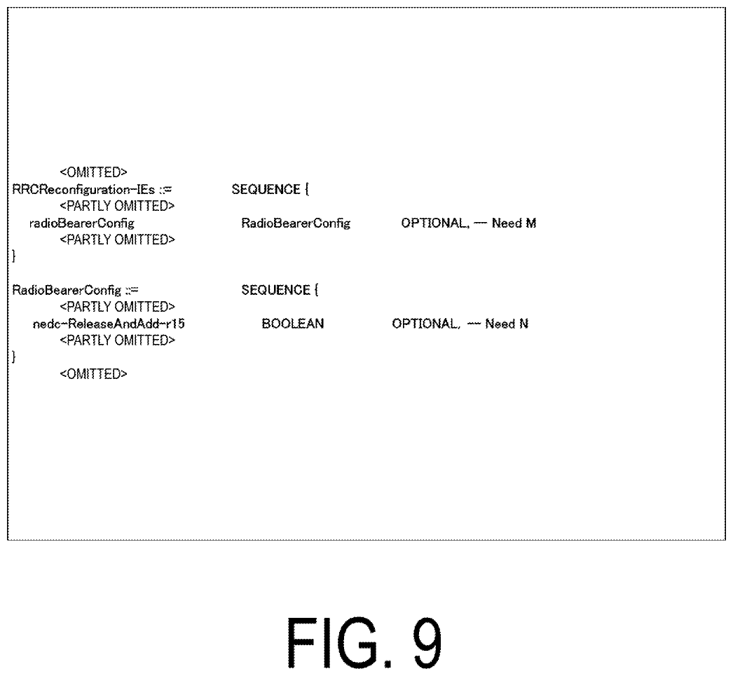

FIG. 9 is an example of Abstract Syntax Notation One (ASN.1) description of information indicating that the release and the addition of the configuration for the secondary cell group are performed at the same time, included in the RRC reconfiguration message in FIG. 8, according to Embodiment 2 of the present invention. In the example of FIG. 9, the description called RRCReconfiguration-IEs, which indicates an information element of the RRC reconfiguration message includes RadioBearerConfig, which is an information element indicating the configuration of the radio bearer, and further the information element indicating the configuration information of the radio bearer includes nedc-ReleaseAndAdd-r15, which is a field of information indicating information that the release and the addition of the configuration for the secondary cell group described above are performed at the same time. The name of the information element or field indicating each information may not be this way.

In Embodiment 2 of the present invention, the processing based on activation of the release of the E-UTRA secondary cell group in the MR-DC from the MCG side to the E-UTRA side within the UE 122 may be referred to as an NE-DC release, or may be referred to as an E-UTRA MR-DC release or an MR-DC E-UTRA SCG release. Alternatively, the processing may be referred to as other names.

As described above, in Embodiment 2 of the present invention, the release processing of the E-UTRA secondary cell group can be performed based on activation of the release of the E-UTRA secondary cell group in the MR-DC from the NR side serving as the MCG to the E-UTRA side within the UE 122. In other words, the terminal apparatus can efficiently perform communication by reducing complexity of protocol processing of MR-DC.

### Embodiment 3

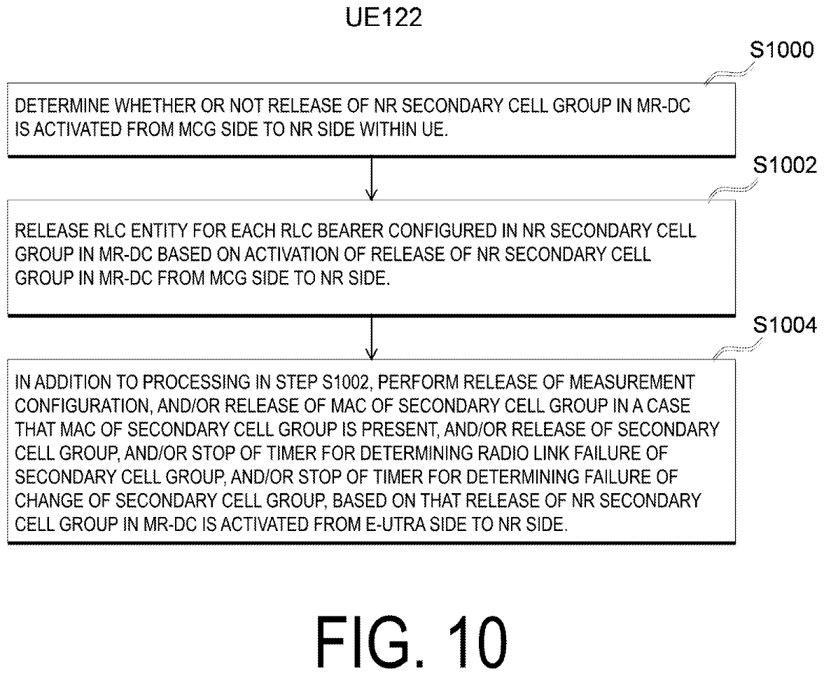

Embodiment 3 of the present invention will be described with reference to FIGS. 10 to 14. Embodiment 3 of the present invention will be described assuming EN-DC and/or NGEN-DC which is MR-DC in which the MCG side is E-UTRA and the SCG side is NR, and/or assuming NR-DC in which both the MCG side and the SCG side are NR in particular. However, the present invention may be applied to other MR-DC or other DC having the MCG and the SCG of the same RAT.

FIG. 10 is an example of the processing method of the UE 122 according to Embodiment 3 of the present invention.

The processing unit 502 of the UE 122 determines whether or not the release of the NR Secondary Cell Group (SCG) in the MR-DC and/or the NR-DC (DC in which RATs are NR in both the MCG and the SCG) is activated from the MCG side to the NR side which is the SCG side within the UE 122 (step S1000). Note that in step S1000, the MR-DC may be EN-DC and/or NGEN-DC and/or NR-DC. The NR secondary cell group may simply be referred to as a secondary cell group. The MCG may be E-UTRA or may be NR. In step S1000, the processing unit 502 of the UE 122 may determine whether or not the release of the MR-DC is activated rather than whether or not the release of the NR Secondary Cell Group (SCG) is activated. In a case that the release of the MR-DC is activated, the release of the NR secondary cell group may be performed (activated) in the procedure of the release of the MR-DC. The release of the EN-DC and the release of the MR-DC may be distinguished from each other. In other words, the release of the EN-DC may be activated in the release of the NR secondary cell group in the EN-DC, or the release of the MR-DC may be activated in the release of the NR secondary cell group in the MR-DC (DC including at least NE-DC and/or NR-DC and no EN-DC). At this time, the release of the MR-DC may be further subdivided into the release of the NE-DC, the release of the NR-DC, and the like.

Next, the processing unit 502 of the UE 122 releases the RLC entity for each RLC bearer configured in the NR secondary cell group in the MR-DC, based on activation of the release of the NR secondary cell group in the MR-DC and/or the NR-DC from the MCG side to the NR side within the UE 122. (step S1002). Note that “for each RLC bearer” described above may be referred to as or may be noted with “for each logical channel or for each logical channel identity”. The MCG may be E-UTRA or may be NR.

In addition to the processing in step S1002 described above, the processing unit 502 of the UE 122 may perform, based on activation of the release of the NR secondary cell group in the MR-DC and/or the NR-DC from the MCG side to the NR side within the UE 122 (or based on the release of the MR-DC being activated), the release of the measurement configuration (e.g., that is associated with the SCG), and/or the release of the MAC of the secondary cell group in a case that the MAC of the secondary cell group is present, and/or the release of the secondary cell group, and/or the stop of the timer for determining the radio link failure of the secondary cell group, and/or the stop of the timer for determining failure of the change of the secondary cell group (step S1004). Here, the measurement configuration to be released may be a measurement configuration configured by an RRC of NR, may be a measurement configuration for the SCG, may be a measurement configuration associated with the SCG, may be a measurement configuration configured by the SCG, may be a measurement configuration configured by an RRC message for performing the configuration of the secondary cell group, or may be a measurement configuration configured by an RRC message of NR (for example, an RRC reconfiguration message) included in an information element (nr-SecondaryCellGroupConfig-r15) for performing the configuration of the secondary cell group of NR included in an RRC message of the E-UTRA.

Note that the processing of the release of the MR-DC may be a separate processing from the processing of the release of the secondary cell group. For example, in a case that the MCG is NR, in a case that the release of the MR-DC is activated, the UE 122 may release the SRB 3 in a case that the SRB 3 is present, or the UE 122 may release a specific measurement configuration and perform a process for releasing the secondary cell group in a case that the UE is configured with the secondary cell group of NR, or the UE 122 may activate the NE-DC release or the release of the configuration for the SCG described in Embodiment 2 in a case that the UE 122 is not configured with a secondary cell group of NR (that is, in a case that the UE 122 is configured with a secondary cell group of E-UTRA). Here, the specific measurement configuration may be a measurement configuration for the SCG, may be a measurement configuration associated with the SCG, may be a measurement configuration configured by the SCG, may be a measurement configuration configured by an RRC message for performing the configuration of the secondary cell group, or may be a measurement configuration configured by an RRC message (for example, an RRC reconfiguration message) included in nr-SCG. The process for releasing the secondary cell group may include some or all processes of (A) resetting the SCG MAC in a case that the SCG MAC is configured, (B) performing the release of the RLC bearer for each RLC bearer that is part of the configuration of the SCG. (C) performing the release of the SCG configuration, (D) stopping the timer for determining a radio link failure of the SCG, and (E) stopping the timer for determining a failure of change of the SCG.

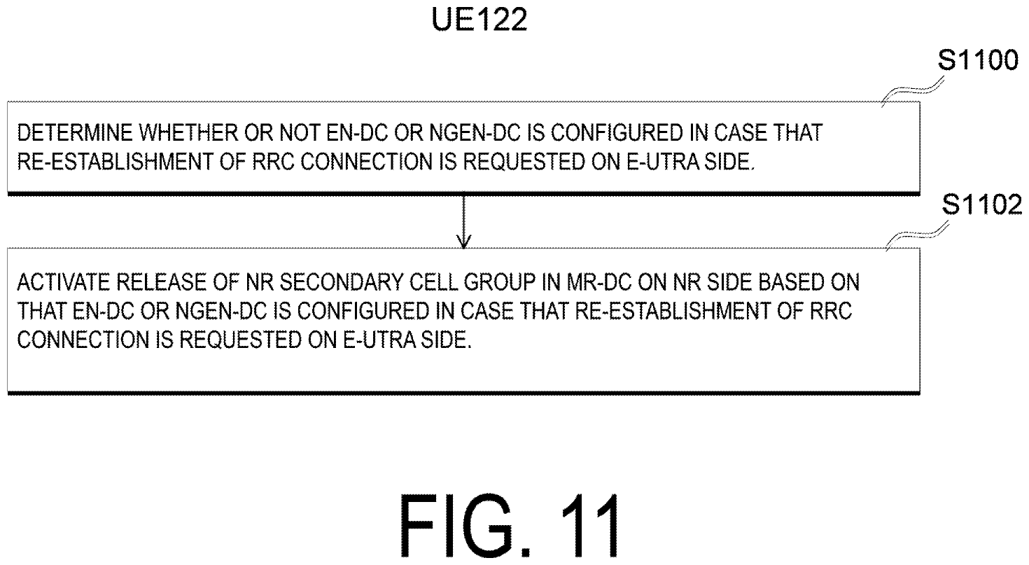

FIG. 11 is a diagram illustrating an example in which the release of the NR secondary cell group in the MR-DC is activated by the E-UTRA side within the UE 122 according to Embodiment 3 of the present invention.

In a case that the re-establishment of the RRC connection (RRC Connection Re-establishment) is requested on the E-UTRA side, the processing unit 502 of the UE 122 may determine whether or not the MR-DC is configured (step S1100), and activate the release of the NR secondary cell group in the MR-DC based on the MR-DC being configured (step S1102). Note that “the MR-DC is configured” may refer to “the MR-DC is processed”, or may refer to “the MR-DC is operated”. “Determining whether or not the MR-DC is configured” described above may be referred to as “determining whether or not the EN-DC or the NGEN-DC is configured”. “May activate the release of the NR secondary cell group in the MR-DC based on the MR-DC being configured” described above may be referred to as “may activate the release of the NR secondary cell group in the MR-DC based on the EN-DC or the NGEN-DC being configured” or “may activate the release of the EN-DC (or the release of the MR-DC) based on the EN-DC or the NGEN-DC being configured”.

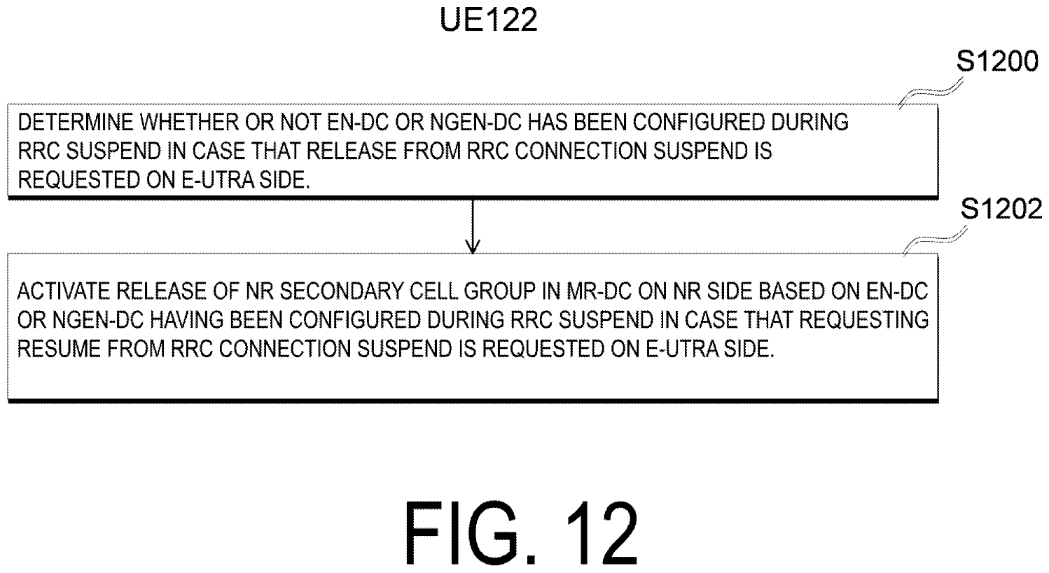

FIG. 12 is a diagram illustrating another example in which the release of the NR secondary cell group in the MR-DC is activated by the E-UTRA side within the UE 122 according to Embodiment 3 of the present invention.

In a case that the resume from the RRC connection suspend is requested on the E-UTRA side, the processing unit 502 of the UE 122 may determine whether or not the MR-DC has been configured during the RRC connection suspend (step S1200), and activate the resume based on the MR-DC having been configured in the release of the NR secondary cell group in the MR-DC (step S1202). “Determining whether or not the MR-DC was configured” described above may be referred to as “determining whether or not the EN-DC or the NGEN-DC was configured”. “May activate the release of the NR secondary cell group in the MR-DC based on the MR-DC having been configured” described above may be referred to as “may activate the release of the NR secondary cell group in the MR-DC based on the EN-DC or the NGEN-DC having been configured” or “may activate the release of the EN-DC (or the release of the MR-DC) based on the EN-DC or the NGEN-DC being configured”.

The activation of the release of the NR secondary cell group in the MR-DC and/or the NR-DC from the MCG side to the NR side within the UE 122 described above may be activated based on other events. For example, the activation may be activated by receiving an RRC connection reconfiguration message including information indicating that the release and the addition of all the configurations for the secondary cell group of NR are performed at the same time in E-UTRA. Note that “based on inclusion of the information indicating that the release and the addition of all the configurations for the secondary cell group of NR are performed at the same time” described above may be referred to as “based on a fact that the information indicating that the release and the addition of all the configurations for the secondary cell group of NR are performed at the same time is true”.

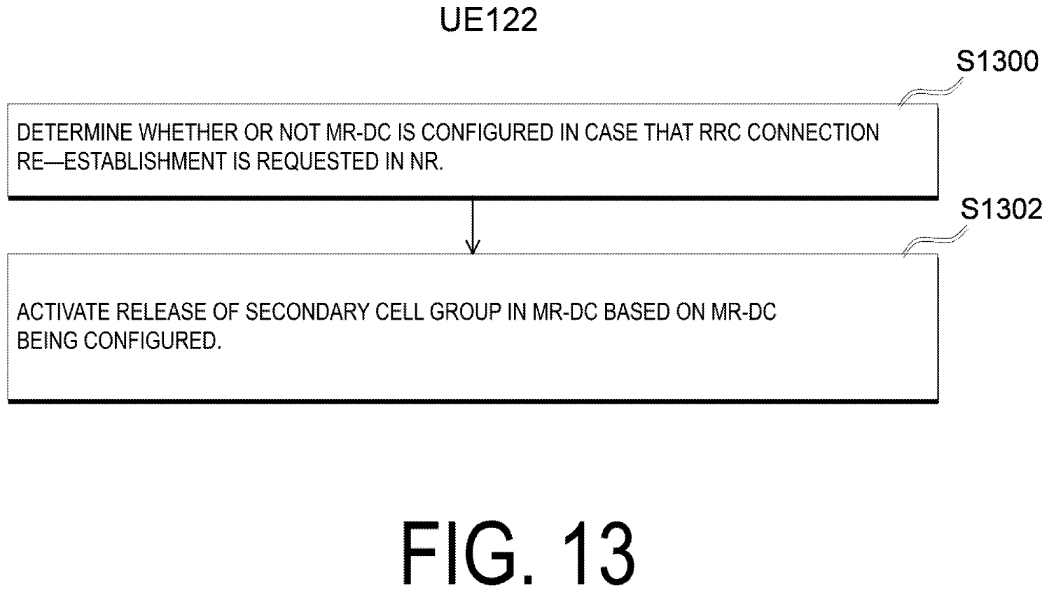

FIG. 13 is an example in which the release of the NR secondary cell group in the MR-DC is activated within the UE 122 according to Embodiment 3 of the present invention.

In a case that the re-establishment of the RRC connection (RRC Connection Re-establishment) is requested in NR, the processing unit 502 of the UE 122 may determine whether or not the MR-DC is configured (step S1300), and activate the release of the secondary cell group in the MR-DC based on the MR-DC being configured (step S1302). Note that “the MR-DC is configured” may refer to “the MR-DC is processed”, or may refer to “the MR-DC is operated”. In step S1302, rather than the release of the secondary cell group being activated, the release of the MR-DC may be performed (activated).

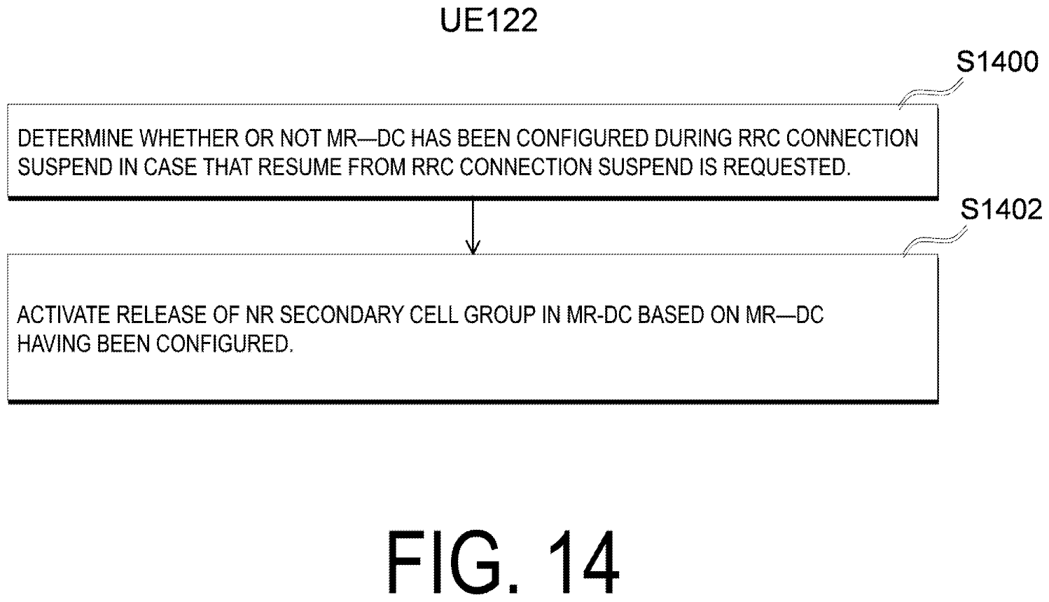

FIG. 14 is another example in which the release of the secondary cell group in the MR-DC is activated within the UE 122 according to Embodiment 3 of the present invention.

In a case that the resume from the RRC connection suspend is requested, the processing unit 502 of the UE 122 may determine whether or not the MR-DC has been configured during the RRC connection suspend (step S1400), and activate the resume based on the MR-DC having been configured in the release of the NR secondary cell group in the MR-DC, which may include activating release of the NR secondary cell group (step S1402). Note that “the MR-DC is configured” may refer to “the MR-DC is processed”, or may refer to “the MR-DC is operated”. In step S1402, rather than the release of the secondary cell group being activated, the release of the MR-DC may be performed (activated).

The activation of the release of the NR secondary cell group in the MR-DC and/or the NR-DC from the MCG side to the NR side within the UE 122 described above may be activated based on other events. For example, the activation may be activated by receiving an RRC connection reconfiguration message including information indicating that the release and the addition of all the configurations for the secondary cell group of NR are performed at the same time in E-UTRA. Note that “based on inclusion of the information indicating that the release and the addition of all the configurations for the secondary cell group of NR are performed at the same time” described above may be referred to as “based on a fact that the information indicating that the release and the addition of all the configurations for the secondary cell group of NR are performed at the same time is true”.

In Embodiment 3 of the present invention, the processing based on activation of the release of the E-UTRA secondary cell group in the MR-DC and/or NR-DC from the MCG side to the NR side within the UE 122 may be referred to as an EN-DC release, may be referred to as an NGEN-DC release, or may be referred to as an EN-DC or NGEN-DC release. The processing may also be referred to as an NR MR-DC release, an MR-DC NR SCG release, an NR SCG release, an SCG release, and the like. Alternatively, the processing may be referred to as other names.

As described above, in Embodiment 3 of the present invention, the release processing of the NR secondary cell group can be performed based on activation of the release of the NR secondary cell group in the MR-DC and/or NR-DC from the MCG side to the NR side within the UE 122. In other words, the terminal apparatus can efficiently perform communication by reducing complexity of protocol processing of MR-DC.

In the embodiments described above, in a case that multiple secondary cell groups of E-UTRA and/or secondary cell groups of NR are configured for the UE 122, the release of only the secondary cell group specified by the RRC message may be activated, or the release of the secondary cell group may be activated for all secondary cell groups, depending on the conditions. For example, in a case that the RRC connection reconfiguration message of E-UTRA and the RRC reconfiguration message of NR indicate the release of the secondary cell group, the release of one or multiple secondary cell groups specified may be activated. In the resume of the RRC connection or the re-establishment of the RRC connection (RRC Connection Re-establishment), the release of all secondary cell groups may be activated. At this time, for example, in a case that the MCG is NR and the SCG includes both the SCG of E-UTRA and the SCG of NR, the release of the NE-DC may be activated for the secondary cell group of E-UTRA, and the release of the MR-DC may be activated for the secondary cell group of NR.

### Embodiment 4

Embodiment 4 of the present invention will be described. Embodiment 4 of the present invention will be described assuming MR-DC in which the MCG side is NR and the SCG side is NR, but the present invention is not limited thereto, and may be applied to other MR-DC.

The UE 122 may perform a procedure of addition and/or modification of a secondary cell in a case that an RRC message (e.g., an RRC reconfiguration message) received from the gNB 108 includes a configuration (CellGroupConfig) for a cell group, and the information for the cell group includes an information element (sCellToAddModList) indicating the addition and/or modification of the secondary cell. sCellToAddModList may include one or more secondary cell configuration information elements, and each secondary cell configuration information element may include an identity (index) for identifying a secondary cell and configuration information for the serving cell corresponding to the identity.

In the procedure of the addition and/or modification of the secondary cell, the UE 122 performs processing of some or all of the following (A) to (C) for each of the identities (indices) of secondary cells not configured to the UE 122 at the current state included in sCellToAddModList. (A) Add the secondary cell to the cell group of interest in sCellToAddModList based on the configuration information for the serving cell corresponding to the index of the secondary cell. (B) Configure the lower layer so that the state of the secondary cell is a deactivated state. (C) For each measurement identity included in a list of measurement identities of a variable VarMeasConfig of a cell group of interest in sCellToAddModList, in a case that the secondary cell is not applied to the measurement associated with the measurement identity in the cell group of interest in sCellToAddModList, and in a case that the secondary cell not applied to the measurement is included in the list of cells (cellsTriggeredList) in which VarMeasReportList for this measurement identity is triggered, delete the secondary cell from this cellsTriggeredList.

The UE 122 modifies the secondary cell of the identity based on the configuration information of the serving cell corresponding to the identity for each of the identities (indexes) of the secondary cells configured to the UE 122 at the current state included in sCellToAddModList.

In this manner, appropriate measurements are enabled by handling variables relating to measurements in consideration of the cell group that adds and/or modifies a secondary cell.

In the procedure of the RRC connection re-establishment, it is contemplated that the Primary Secondary Cell (PSCell) serving as the primary cell of the secondary cell group and the secondary cell are deleted (released) in order to account for the MR-DC. However, measurement configurations associated with deletion (release) of cells are not defined, so the measurement configuration can be appropriately configured by the embodiments of the present invention. Processing for measurement configurations at various conditions can be managed in a centralized manner by activating the release of the MR-DC rather than deleting (releasing) the PSCell and the secondary cell.

Various aspects of the UE 122 (terminal apparatus) and the gNB 108 and/or the eNB 102 (base station apparatus) according to the embodiments of the present invention will be described.

A first aspect of the present invention is a terminal apparatus including: a processing unit configured to release a measurement configuration configured for at least a secondary cell group in a case that the NR secondary cell group is configured in the MR-DC, or activate the release of the NE-DC in a case that the NR secondary cell group is not configured, based on activation of the release of the MR-DC.

In the first aspect, the terminal apparatus further activates the release of the MR-DC in a case that the MR-DC is configured based on activation of the re-establishment of the RRC connection and/or activation of the resume of the RRC connection.

A second aspect of the present invention is a base station apparatus including: a processing unit configured to cause a terminal apparatus for which an NR secondary cell group is configured in the MR-DC to release a measurement configuration configured for at least the secondary cell group, or cause the terminal apparatus for which the NR secondary cell group is not configured to activate the release of the NE-DC, by notifying the terminal apparatus of the release of the MR-DC.

A third aspect of the present invention is a method applied to a terminal apparatus, the method including at least the step of: releasing a measurement configuration configured for at least a secondary cell group in a case that the NR secondary cell group is configured in the MR-DC, or activating the release of the NE-DC in a case that the NR secondary cell group is not configured, based on activation of the release of the MR-DC.

In the third aspect, the method includes the step of: activating the release of the MR-DC in a case that the MR-DC is configured, based on activation of the re-establishment of the RRC connection and/or activation of the resume of the RRC connection.

A fourth aspect of the present invention is a method applied to a base station apparatus, the method including at least the step of: causing a terminal apparatus for which an NR secondary cell group is configured in the MR-DC to release a measurement configuration configured for at least the secondary cell group, or causing the terminal apparatus for which the NR secondary cell group is not configured to activate the release of the NE-DC, by notifying the terminal apparatus of the release of the MR-DC.

A fifth aspect of the present invention is an integrated circuit mounted on a terminal apparatus, the integrated circuit causing the terminal apparatus to perform: releasing a measurement configuration configured for at least a secondary cell group in a case that the NR secondary cell group is configured in the MR-DC, or activating the release of the NE-DC in a case that the NR secondary cell group is not configured, based on activation of the release of the MR-DC.

In a fifth aspect, the integrated circuit causes the terminal apparatus to perform: activating the release of the MR-DC in a case that the MR-DC is configured based on activation of the re-establishment of the RRC connection and/or activation of the resume of the RRC connection.

A sixth aspect of the present invention is an integrated circuit mounted on a base station apparatus, the integrated circuit causing the base station apparatus to perform: causing a terminal apparatus for which an NR secondary cell group is configured in the MR-DC to release a measurement configuration configured for at least the secondary cell group, or causing the terminal apparatus for which the NR secondary cell group is not configured to activate the release of the NE-DC, by notifying the terminal apparatus of the release of the MR-DC.

A program running on an apparatus according to an aspect of the present invention may serve as a program that controls a Central Processing Unit (CPU) and the like to cause a computer to operate in such a manner as to realize the functions of the above-described embodiments according to the present invention. Programs or the information handled by the programs are temporarily read into a volatile memory, such as a Random Access Memory (RAM) while being processed, or stored in a non-volatile memory, such as a flash memory, or a Hard Disk Drive (HDD), and then read by the CPU to be modified or rewritten, as necessary.

Note that the apparatuses in the above-described embodiments may be partially enabled by a computer. In such a case, a program for realizing such control functions may be recorded on a computer-readable recording medium to cause a computer system to read the program recorded on the recording medium to perform the program. It is assumed that the “computer system” mentioned here refers to a computer system built into the apparatuses, and the computer system includes an operating system and hardware components such as a peripheral device. The “computer-readable recording medium” may be any of a semiconductor recording medium, an optical recording medium, a magnetic recording medium, and the like.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. The above-described program may be configured to realize some of the functions described above, and additionally may be configured to realize the functions described above, in combination with a program already recorded in the computer system.

Each functional block or various characteristics of the apparatuses used in the above-described embodiments may be implemented or performed on an electric circuit, that is, typically an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor, or the processor may be a processor of known type, a controller, a micro-controller, or a state machine instead. The general-purpose processor or the above-mentioned circuits may include a digital circuit, or may include an analog circuit. In a case that with advances in semiconductor technology, a circuit integration technology appears that replaces the present integrated circuits, it is also possible to use an integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an audio/visual (AV) apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. A configuration in which components, which are described in the embodiment described above, having similar effects are interchanged is also included in the present invention.

1. A terminal apparatus comprising:
a receiver configured to receive a first message; and
a controller configured to perform a measurement based on a measurement configuration included in the first message, the measurement configuration being associated with a secondary cell group,
wherein the controller releases the measurement configuration based on a release of Multi Radio access technology (RAT)-Dual Connectivity (MR-DC).

2. The terminal apparatus according to claim 1, wherein
the controller releases the MR-DC in a case that the MR-DC is configured based on at least one of re-establishment of a radio resource control (RRC) connection and resumption of an RRC connection.

3. A base station apparatus comprising:
a processing unit configured to notify a terminal apparatus, for which a secondary cell group of new radio (NR) is configured in Multi Radio access technology (RAT)-Dual Connectivity (MR-DC), of a release of the MR-DC,
wherein notification of the release of the MR-DC causes the terminal apparatus to release a measurement configuration associated with the secondary cell group.

4. A method applied to a terminal apparatus, the method comprising:
receiving a first message;
performing a measurement based on a measurement configuration included in the first message, the measurement configuration being associated with a secondary cell group; and
releasing the measurement configuration based on a release of Multi Radio access technology (RAT)-Dual Connectivity (MR-DC).

5. The method according to claim 4, the method further comprising:
releasing MR-DC in a case that MR-DC is configured based on at least one of re-establishment of a radio resource control (RRC) connection and resumption of an RRC connection.

6. A method applied to a base station apparatus, the method comprising:
notifying a terminal apparatus, for which a secondary cell group of new radio (NR) is configured in Multi Radio access technology (RAT)-Dual Connectivity (MR-DC), of a release of the MR-DC,
wherein notification of the release of the MR-DC causes the terminal apparatus to release a measurement configuration associated with the secondary cell group.

7. An integrated circuit mounted on a terminal apparatus, the integrated circuit causing the terminal apparatus to:
receive a first message;
perform a measurement based on a measurement configuration included in the first message, the measurement configuration being associated with a secondary cell group; and
release the measurement configuration based on a release of Multi Radio access technology (RAT)-Dual Connectivity (MR-DC).

8. The integrated circuit according to claim 7, wherein the integrated circuit further causes the terminal apparatus to:
release the MR-DC in a case that the MR-DC is configured based on at least one of re-establishment of a radio resource control (RRC) connection and resumption of an RRC connection.

9. An integrated circuit mounted on a base station apparatus, the integrated circuit causing the base station apparatus to:
notify a terminal apparatus, for which a secondary cell group of new radio (NR) is configured in Multi Radio access technology (RAT)-Dual Connectivity (MR-DC), of a release of the MR-DC,
wherein notification of the release of the MR-DC causes the terminal apparatus to release a measurement configuration associated with the secondary cell group.
